(19) United States
(12) Patent Application Publication
(10) Pub. No.: US 2016/0031321 A1
(43) Pub. Date: Feb. 4, 2016

(54) PREDICTED ARRIVAL POINT PRESENTATION DEVICE AND COMPUTER READABLE MEDIUM

(71) Applicant: KABUSHIKI KAISHA TOYOTA CHUO KENKYUSHO, Nagakute-shi (JP)

(72) Inventors: Eiichi ONO, Nagakute-shi (JP); Yuji MURAGISHI, Nagakute-shi (JP); Hideyuki MUKAE, Nagakute-shi (JP)

(21) Appl. No.: 14/804,997

(22) Filed: Jul. 21, 2015

(30) Foreign Application Priority Data
Jul. 30, 2014 (JP) 2014-155366

(51) Int. Cl. B60K 35/00; B62D 5/04

(52) U.S. Cl. CPC B60K 35/00; B62D 5/04; B60K 2350/2056

(57) ABSTRACT

A marker notification position calculation unit 36 predicts, based on a target course, a target location of arrival of a vehicle after a forward gaze time of a driver while the vehicle is travelling along a route under driving assistance, and an output device 92 presents, at a position on a windshield of the vehicle, a marker indicating the target location of arrival that is predicted.

### CROSS-REFERENCE TO RELATED APPLICATIONS

This application is based on and claims priority under 35 USC 119 from Japanese Patent Application No. 2014-155366, filed Jul. 30, 2014.

### BACKGROUND OF THE INVENTION

1. Field of the Invention

The present invention relates to a predicted arrival point presentation device and a computer readable medium, and, in particular, relates to a predicted arrival point presentation device and a computer readable medium for presenting a predicted arrival point of a vehicle.

2. Description of the Related Art

Hitherto, a method has been known in which driving assistance is given to a driver by superimposed display of the route that the vehicle should take using an arrow on a vehicle windshield to indicate route information obtained from a navigation system (see Japanese Patent Application Laid-Open (JP-A) No. 2011-203053).

However, in conventional technology, although the intent of a navigation system serving as a driving assistance system can be conveyed to the driver, there is an issue in that a display reflecting the intent of the driver has not been achieved.

### SUMMARY OF THE INVENTION

The present invention has been made in view of the above circumstances and provides a predicted arrival point presentation device and a computer readable medium.

A predicted arrival point presentation device according to a first aspect includes an arrival location prediction unit that predicts a target location of arrival of a vehicle after a forward gaze time of a driver based on a target course while the vehicle is travelling along a route under driving assistance, and a presentation unit that presents a marker indicating the target location of arrival predicted by the arrival location prediction unit at a position on a windshield of the vehicle.

According to the first aspect, the arrival location prediction unit predicts the target location of arrival of the vehicle after the forward gaze time of the driver based on the target course while the vehicle is travelling along the route under driving assistance, and the presentation unit presents the marker indicating the target location of arrival predicted by the arrival location prediction unit at a position on the windshield of the vehicle.

Further, according to a second aspect, a computer readable medium stores a program that causes a computer to function as the respective component elements configuring the above-described predicted arrival point presentation device.

### BRIEF DESCRIPTION OF THE DRAWINGS

Exemplary embodiments of the present invention will be described in detail based on the following figures, wherein:

FIG. 1A is an illustrative diagram illustrating an angle formed between a travelling direction of a vehicle and a target waypoint;

FIG. 1B is an illustrative diagram illustrating an angle formed between a travelling direction of a vehicle and a target waypoint;

FIG. 2A is an illustrative diagram illustrating a relative depression angle;

FIG. 2B is an illustrative diagram illustrating an angle formed between a vehicle front-rear direction and a direction of a target waypoint;

FIG. 3A is an illustrative diagram illustrating a state in which a driver's head has been displaced;

FIG. 3B is an illustrative diagram illustrating separation between a driver's head and a steering wheel center;

FIG. 3C is an illustrative diagram illustrating a relationship of a relative angle between a steering wheel angle and a forward gaze angle when a driver's head has been displaced;

FIG. 4A is a diagram for explaining a relative angle between a steering wheel center depression angle and a view cut-off line depression angle;

FIG. 4B is an illustrative diagram illustrating a case in which a forward gaze point is present above a view cut-off line;

FIG. 5 is a block diagram illustrating a functional configuration of a predicted arrival point presentation device according to a first exemplary embodiment of the present invention;

FIG. 6 is a diagram illustrating a relationship between a gear ratio adjusting unit and a steering gear ratio changing unit;

FIG. 7 is a diagram illustrating an example of a map indicating a relationship between a yaw angular velocity gain k and a vehicle speed v;

FIG. 8 is a flowchart illustrating a marker presentation processing routine of a predicted arrival point presentation device according to the first exemplary embodiment of the present invention;

FIG. 9 is a flowchart illustrating a gear ratio adjustment processing routine of a predicted arrival point presentation device according to the first exemplary embodiment of the present invention;

FIG. 10 is a block diagram illustrating a functional configuration of a predicted arrival point presentation device according to a second exemplary embodiment of the present invention;

FIG. 11 is a block diagram illustrating a functional configuration of a predicted arrival point presentation device according to a third exemplary embodiment of the present invention;

FIG. 12 is a flowchart illustrating a marker presentation processing routine of a predicted arrival point presentation device according to the third exemplary embodiment of the present invention;

FIG. 13 is a flowchart illustrating a marker presentation processing routine of a predicted arrival point presentation device according to the third exemplary embodiment of the present invention;

FIG. 14 is a block diagram illustrating a functional configuration of a predicted arrival point presentation device according to a fourth exemplary embodiment of the present invention;

FIG. 15 is a flowchart illustrating a marker presentation processing routine of a predicted arrival point presentation device according to the fourth exemplary embodiment of the present invention;

FIG. 16 is a block diagram illustrating a functional configuration of a predicted arrival point presentation device according to a fifth exemplary embodiment of the present invention;

FIG. 17 is a block diagram illustrating a functional configuration of a predicted arrival point presentation device according to a sixth exemplary embodiment of the present invention; and

FIG. 18 is a flowchart illustrating a marker presentation processing routine of a predicted arrival point presentation device according to the sixth exemplary embodiment of the present invention.

### DETAILED DESCRIPTION OF THE INVENTION

Detailed explanation follows regarding exemplary embodiments of the present invention with reference to the drawings.

Principles of Exemplary Embodiments of the Present Invention

First, explanation follows regarding principles of the exemplary embodiments of the present invention. As a driver model, it is known that a forward gaze angle θ_{gaze} that is a directional angular difference between a gaze point on a predicted arrival track and a vehicle velocity, and a yaw angular velocity r after a fixed time period, have a proportionality relationship that is independent of vehicle speed, as represented by Equation (1) below (see Japanese Patent No. 5396873).

r(t+τ)=kᵣ·θ_{gaze}(t) (1)

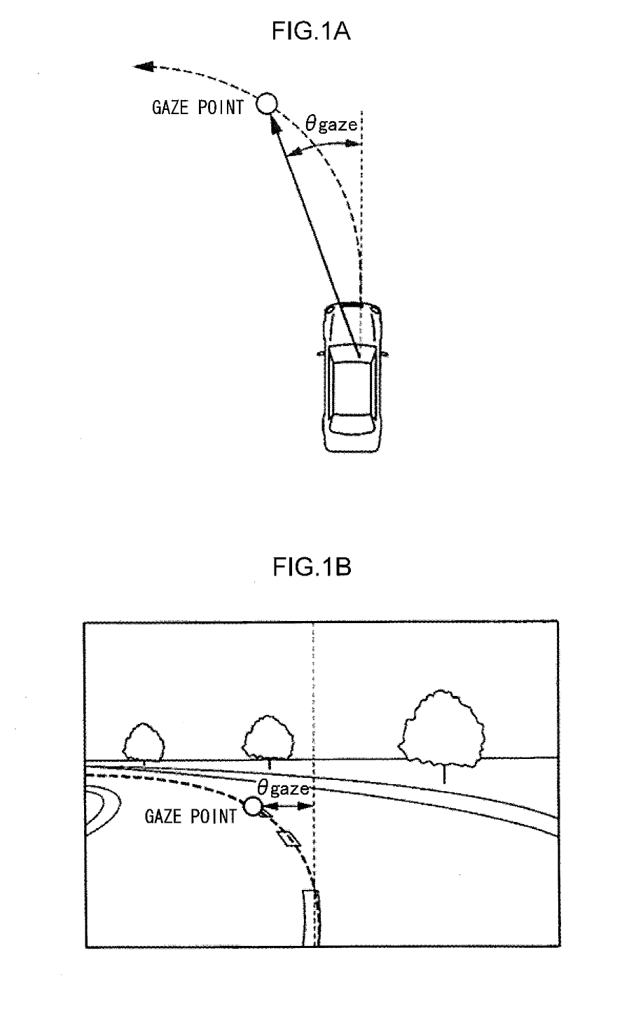

Note that r represents the yaw angular velocity. Moreover, τ represents dead time. Moreover, θ_{gaze} represents the forward gaze angle (as illustrated in FIG. 1A and FIG. 1B, the angle formed between a predicted position after a gaze time and a target course). Moreover, kᵣ represents a transmission gain to obtain the yaw angular velocity r from the forward gaze angle θ_{gaze}. This yields a result representing operation of the steering wheel by the driver, based on the forward gaze angle θ_{gaze}. The relationship between a forward gaze time T_{gaze} and the transmission gain kᵣ to obtain the yaw angular velocity r from the forward gaze angle θ_{gaze}, as represented by Equation (2) below, is established as a result of theoretical analysis. The relationship represented by Equation (3) below, between forward gaze time T_{gaze} and dead time τ, is also established. Note that forward gaze time T_{gaze} is set constant at from 2.5 seconds to 3.5 seconds in the exemplary embodiments of the present invention.

kᵣ·T_{gaze}=2 (2)

T_{gaze}=3·τ (3)

Steering wheel control that follows a route with minimal unnerving sensation can be implemented by applying the above driver model and controlling the actual front wheel steering angle such that the yaw angular velocity after dead time τ takes the value of Equation (1) (see Japanese Patent No. 5417856).

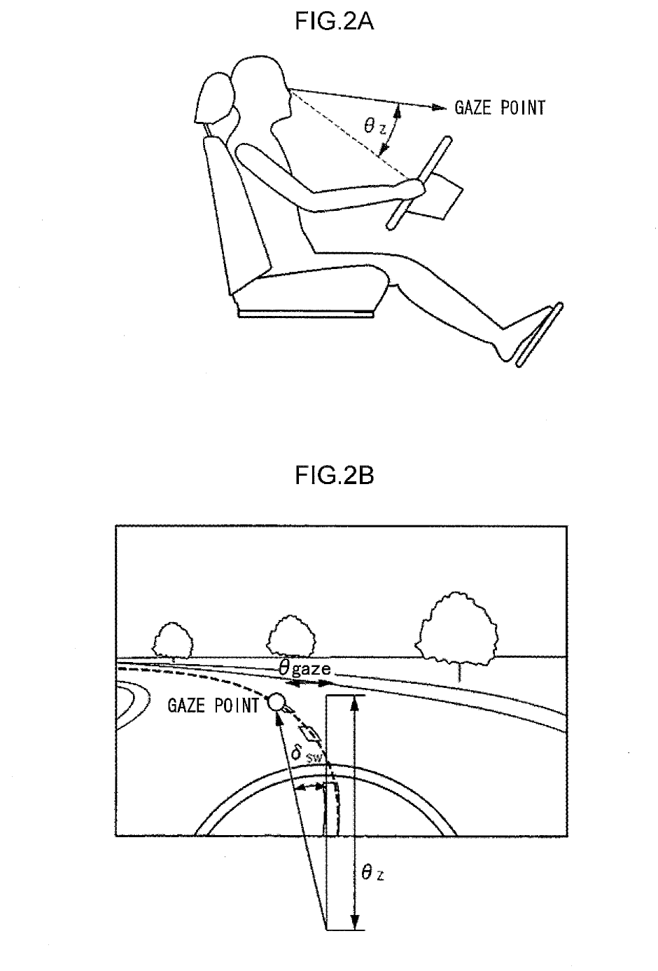

The driver thus operates the steering wheel based on the forward gaze angle θ_{gaze}. Accordingly, since the intention of the driver is to pass through a position corresponding to that after the forward gaze time T_{gaze}, as illustrated in FIG. 2B, aligning the direction of the gaze point that is also an output of vehicle motion and the steering wheel angle δ_{sw} that is an amount of operation by the driver improves a sense of unity between the vehicle and driver, operability, agility, etc. (see Japanese Patent No. 5291640).

Although the forward gaze angle θ_{gaze} as defined in FIG. 1A and FIG. 1B takes the direction of travel velocity of the vehicle as a reference, the direction of the vehicle body in which the driver is seated should be taken as a reference in order to align to the relationship with the steering wheel angle δ_{sw}. Hence, a vehicle body slip angle β is added to the forward gaze angle θ_{gaze} in the present exemplary embodiment.

θ_{gazeβ}=θ_{gaze}+β (4)

The steering wheel angle δ is then aligned therewith. As illustrated in FIG. 2A, Equation (5) below is obtained as a condition for aligning the steering wheel angle δ_{sw} with the direction of the gaze point, wherein a relative depression angle between the steering wheel center and the gaze point is denoted θ_{z}.

$$tan ( {δ}_{sw} + {K}_{roll} \cdot r \cdot v ) = \frac{{θ}_{gaze β}}{{θ}_{z}} = \frac{{θ}_{gaze} + β}{{θ}_{z}} \qquad ( 5 )$$

Note Equation (5) above takes into consideration that the steering wheel angle δ_{sw} appears to be diminished by a roll angle arising from a roll motion. Kᵣₒₗₗ represents the roll ratio. Given that the forward gaze time T_{gaze} and the transmission gain kᵣ to obtain the yaw angular velocity r from the forward gaze angle θ_{gaze} hold the relationship represented by Equation (2), the forward gaze angle θ_{gaze} is expressed as Equation (6) below.

$${θ}_{gaze} = \frac{{T}_{gaze}}{2} \cdot r \qquad ( 6 )$$

Moreover, Equation (5) can be expressed as Equation (8) by expressing the vehicle body slip angle β as Equation (7) using a linear model of vehicle motion.

$$\begin{matrix}β = ( \frac{{l}_{r}}{v} - \frac{m {l}_{r}}{2 l {C}_{r}} \cdot v ) \cdot r & ( 7 ) \\ tan ( {δ}_{sw} + {K}_{roll} \cdot r \cdot v ) = \frac{\frac{{T}_{gaze }}{2} + \frac{{l}_{r}}{v} - \frac{{ml}_{r}}{2 l {C}_{r}} \cdot v}{{θ}_{z}} & ( 8 )\end{matrix}$$

Cᵣ represents the rear wheel corning power. Moreover, l represents the wheelbase. Moreover, lᵣ represents the distance between the center of mass and the rear axle. Moreover, m represents the vehicle mass. Moreover, v represents the vehicle speed.

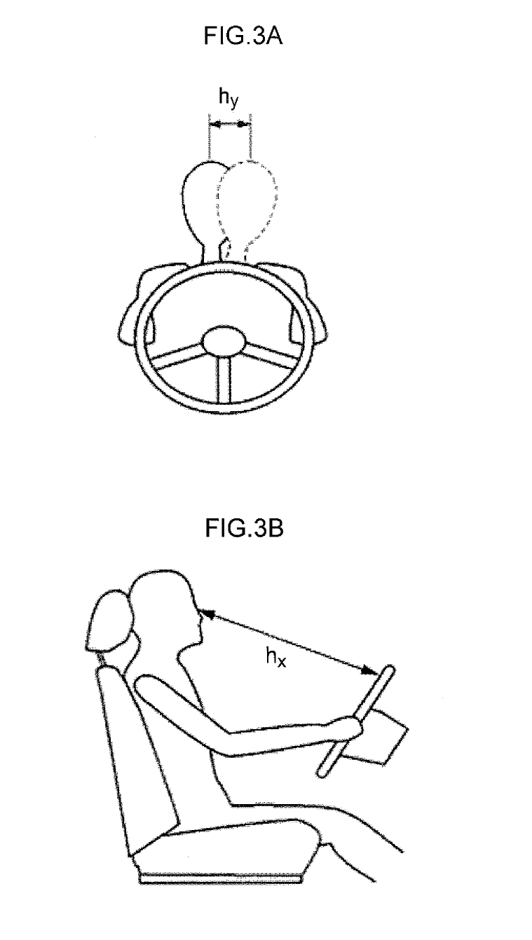

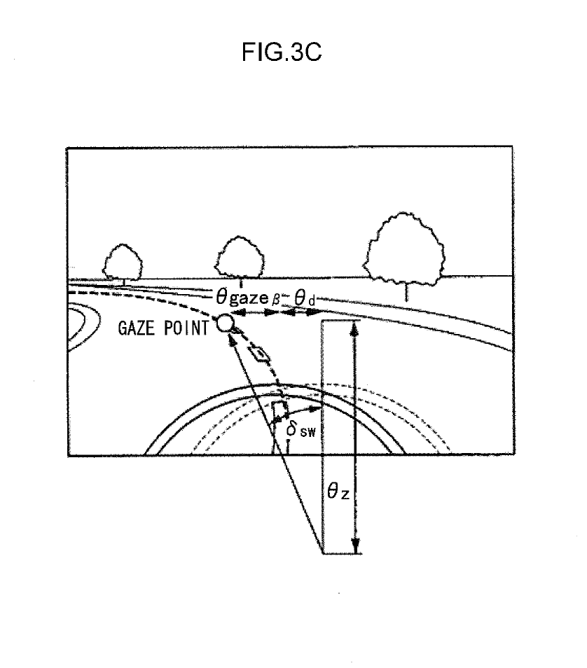

The relationship in Equation (8) is a relationship equation that assumes that the position of the viewpoint of the driver does not change. However, it is necessary to consider the effect of lateral acceleration during actual vehicle travelling that changes the driver's posture, namely, the position of the viewpoint. As illustrated in FIG. 3A, when the driver's head has been displaced by h_{y} in a direction opposing the lateral acceleration proportionately to the lateral acceleration of the vehicle, the center of the steering wheel as viewed by the driver is displaced toward the outside of the turn by θ_{d} as found by Equation (9).

$${θ}_{d} = {tan}^{- 1} \frac{{h}_{y}}{{h}_{x}} \qquad ( 9 )$$

Note that hₓ is the distance between the driver's head and the center of the steering wheel (see FIG. 3B).

Accordingly, from FIG. 3C, a condition for aligning the direction of the steering angle δ_{sw} during displacement of the driver's head (the direction of the reference position of the steering wheel) with the direction of the forward gaze point is represented by Equation (10) below.

$$tan ( {δ}_{sw} - {K}_{roll} \cdot r \cdot v ) = \frac{( \frac{{T}_{gaze }}{2} + \frac{{l}_{r}}{v} - \frac{{ml}_{r}}{2 l {C}_{r}} \cdot v ) \cdot r + {θ}_{d}}{{θ}_{z}} \qquad ( 10 )$$

In the present exemplary embodiment, when lateral acceleration is generated at 9.8 m/s², displacement h_{y}=h_{y max}, and θ_{d} is formulated as Equation (11) below.

$${θ}_{d} = {tan}^{- 1} \frac{{h}_{y max} \cdot {g}_{y}}{9.8 \cdot {h}_{x}} \qquad ( 11 )$$

Moreover, a relationship between the lateral acceleration and the yaw angular velocity r (a condition such that the slip angle β does not increase) can be expressed by Equation (12) below.

g_{y}=v·r (12)

The relationship represented by Equation (13) can be derived when Equation (11) and Equation (12) are considered.

$$tan ( {δ}_{sw} - {K}_{roll} \cdot r \cdot v ) = \frac{( \frac{{T}_{gaze }}{2} + \frac{{l}_{r}}{v} - \frac{{ml}_{r}}{2 l {C}_{r}} \cdot v ) \cdot r + {tan}^{- 1} \frac{{h}_{y max} \cdot r \cdot v}{9.8 \cdot {h}_{x}}}{{θ}_{z}} \qquad ( 13 )$$

The relative depression angle θ_{z} holds the relationship represented by Equation (14) based on a steering wheel center depression angle θ_{zsw} from the driver's viewpoint to the steering wheel center, the forward gaze time T_{gaze}, and an eye point height h_{eye}.

$${θ}_{z} = {θ}_{zsw} - {tan}^{- 1} \frac{{h}_{eye}}{{T}_{gaze} \cdot v} ≅ {θ}_{zsw} - \frac{{h}_{eye}}{{T}_{gaze} \cdot v} \qquad ( 14 )$$

Given Equation (14), Equation (13) can be written as Equation (15).

$$tan ( {δ}_{sw} - {K}_{roll} \cdot r \cdot v ) = \frac{( \frac{{T}_{gaze}}{2} + \frac{{l}_{r}}{v} - \frac{m {l}_{r}}{2 {lC}_{r}} \cdot v ) \cdot r + {tan}^{- 1} \frac{{h}_{y max} \cdot r \cdot v}{9.8 \cdot {h}_{x}}}{{θ}_{zsw} - \frac{{h}_{eye}}{{T}_{gaze} \cdot v}} \qquad ( 15 )$$

Assuming that the steering wheel angle is in a small steering wheel angle region of 10° or less, an approximation for the yaw angular velocity gain k, which is the gain to obtain the yaw angular velocity r from the steering wheel angle, can be derived by Equation (16).

$$( 16 )$$

$$\begin{matrix}k = \frac{{θ}_{zsw} - \frac{{h}_{eye}}{{T}_{gaze} \cdot v}}{\frac{{T}_{gaze}}{2} - \frac{{K}_{roll} \cdot {h}_{eye}}{{T}_{gaze}} + \frac{{l}_{r}}{v} - ( \frac{m {l}_{r}}{2 l {C}_{r}} - {K}_{roll} \cdot {θ}_{zsw} - \frac{{h}_{ymax}}{9.8 \cdot {h}_{x}} ) \cdot v} \\ = \frac{{θ}_{zsw} \cdot v - \frac{{h}_{eye}}{{T}_{gaze}}}{( {K}_{roll} \cdot {θ}_{zsw} + \frac{{h}_{ymax}}{9.8 \cdot {h}_{x}} - \frac{{ml}_{r}}{2 {lC}_{r}} ) \cdot {v}^{2} + ( \frac{{T}_{gaze}}{2} - \frac{{K}_{roll} \cdot {h}_{eye}}{{T}_{gaze}} ) \cdot v + {l}_{r}}\end{matrix}$$

Equation (16) has a negative coefficient only for the constant term in the numerator, and the other term of the numerator and the terms of the divisor represent a function of the vehicle speed that is a linear rational function included in a bilinear function having positive coefficients.

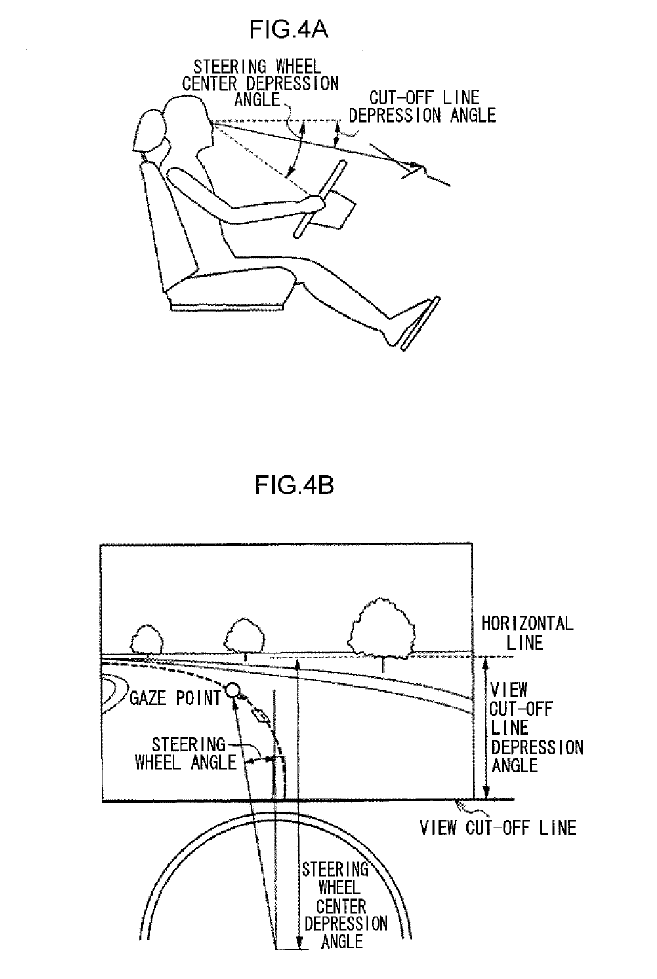

As illustrated in FIG. 4B, Equation (16) only establishes the forward gaze point corresponding to the forward gaze time T_{gaze} in a vehicle speed region present above a cut-off line of the driver's forward field of vision. The driver cannot see any forward gaze points corresponding to the forward gaze time T_{gaze} in a vehicle speed region below such a vehicle speed, and so the driver operates the steering wheel based on visual information above the cut-off line.

It is therefore assumed that in this vehicle speed region the forward gaze point is above the cut-off line, and a yaw angular velocity gain is found that aligns the direction of a predicted arrival point as it disappears under the cut-off line (a forward gaze point on the cut-off line) and the direction of the reference position of the steering wheel.

A vehicle speed v₀ when the predicted arrival point after the forward gaze time T_{gaze} (a target waypoint on the target course) reaches the cut-off line of the forward field of view by the driver can thus be written as Equation (17), from a cut-off line depression angle θ_{zfview} (see FIG. 4A) and the eye point height h_{eye}.

$${v}_{0} = \frac{{h}_{eye}}{{T}_{gaze} \cdot {θ}_{zfview}} \qquad ( 17 )$$

At the vehicle speed v₀ expressed by Equation (17) and lower, Equation (19) can be obtained by substituting the forward gaze time T_{gaze} of Equation (16) with Equation (18) below. The direction of the predicted arrival point that disappears at the cut-off line (the forward gaze point on the cut-off line) can accordingly be aligned with the direction of the reference position of the steering wheel.

$${T}_{gaze 0} = \frac{{h}_{eye}}{{θ}_{zfview} \cdot v} \qquad ( 18 )$$

$$( 19 )$$

$$\begin{matrix}k = \frac{{θ}_{zsw} \cdot v - {θ}_{2 fview} \cdot v}{( {K}_{roll} \cdot {θ}_{zsw} + \frac{{h}_{ymax}}{9.8 \cdot {h}_{x}} - \frac{{ml}_{r}}{2 {lC}_{r}} ) \cdot {v}^{2} + ( \frac{{h}_{eye}}{2 {θ}_{zview} \cdot v} - {K}_{roll} \cdot {h}_{eye} \cdot v ) \cdot v + {l}_{r}} \\ = \frac{{θ}_{zsw} \cdot v - {θ}_{2 fview} \cdot v}{( {K}_{roll} \cdot {θ}_{zsw} + \frac{{h}_{ymax}}{9.8 \cdot {h}_{x}} - \frac{{ml}_{r}}{2 {lC}_{r}} - {K}_{roll} \cdot {h}_{eye} ) \cdot {v}^{2} + \frac{{h}_{eye}}{2 \cdot {θ}_{zview}} + {l}_{r}}\end{matrix}$$

The squared vehicle speed term in the divisor can be ignored since Equation (19) is a relationship equation employed in a low speed region, enabling the relationship expressed by Equation (20) to be approximated.

$$k = \frac{{θ}_{zsw} - {θ}_{zfview}}{\frac{{h}_{eye}}{2 \cdot {θ}_{zview}} + {l}_{r}} \cdot v = \frac{{θ}_{zsw} - {θ}_{zfview}}{\frac{{L}_{fview}}{2} + {l}_{r}} \cdot v \qquad ( 20 )$$

L_{fview} is the distance between a road surface position on the cut-off line of the driver's field of view, and the driver' position.

Equation (20) expresses the yaw angular velocity gain as the product of a coefficient and the vehicle speed, wherein the coefficient is taken as the value of the relative depression angle between the depression angle of the steering wheel center as viewed by the driver, and the depression angle of the cut-off line of the forward field of view, after dividing the sum of the length of half of the distance from the position on the road surface positioned on the cut-off line of the driver's forward field of view to the position of the driver, and the distance between the center of gravity of the vehicle and the rear axle.

As described above, setting the characteristics of the yaw angular velocity r to correspond to the steering wheel angle enables the direction of the reference position of the steering wheel and the direction of the forward gaze point to be aligned in the vehicle speed region present where the forward gaze point is above the cut-off line of the driver's forward field of view as viewed from the driver's viewpoint. Moreover, the direction of the reference position of the steering wheel and the direction of the forward gaze point assumed to be on the cut-off line can be aligned in a vehicle speed region below the above-mentioned vehicle speed region. Accordingly, vehicle motion characteristics are obtained that always remain desirable from a very low speed region to a high speed region, and a sense of unity with the vehicle is improved. Moreover, taking the vehicle arrival point to be a constant distance ahead as the forward gaze point irrespective of speed in a very low speed region that sets the forward gaze point on the cut-off line gives a value for the forward gaze time T_{gaze} that is inversely proportional to the vehicle speed v. This point differs from conventional technology in which the forward gaze time is assumed to be constant, and resolves the issue of the actual gear ratio becoming too quick due to the yaw angular velocity gain being proportional to the vehicle speed v due to setting a forward gaze time T_{gaze} proportional to the vehicle speed v.

Configuration of a Predicted Arrival Point Presentation Device According to a First Exemplary Embodiment of the Present Invention

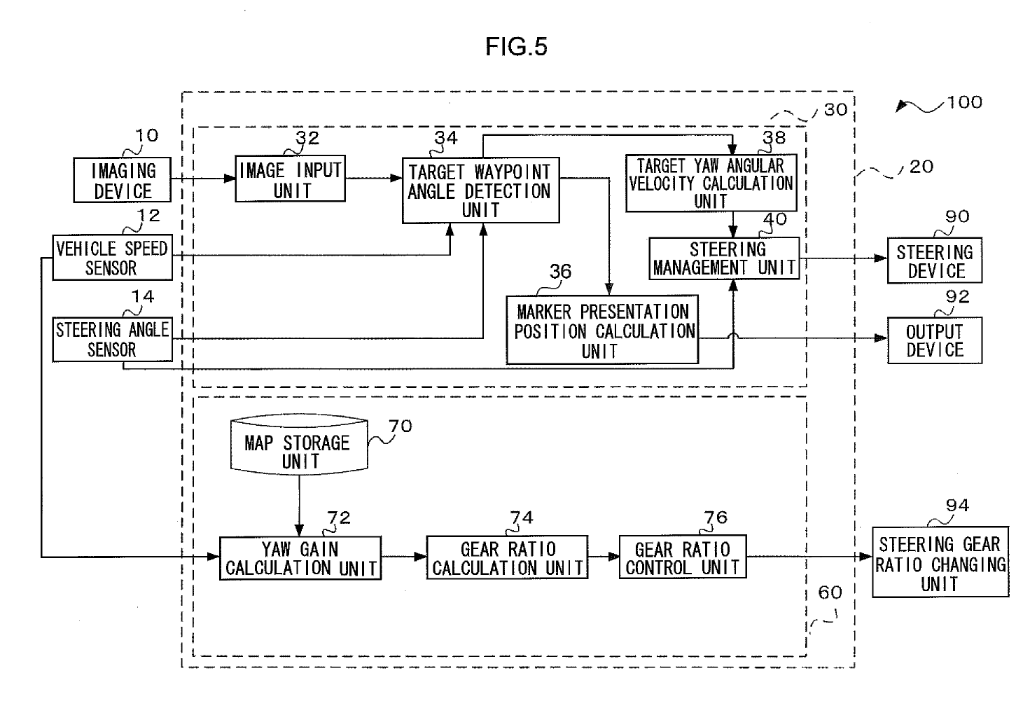

Explanation next follows regarding configuration of a predicted arrival point presentation device 100 according to a first exemplary embodiment of the present invention. As illustrated in FIG. 5 the predicted arrival point presentation device 100 according to the first exemplary embodiment of the present invention can be configured by a computer including a CPU, RAM, and ROM stored with programs and various data for executing a gear ratio control processing routine and a marker presentation processing routine, described later. The predicted arrival point presentation device 100 includes an imaging device 10, a vehicle speed sensor 12, a steering angle sensor 14, an operation unit 20, a steering device 90, an output device 92, and a steering gear ratio changing unit 94 as functionally illustrated in FIG. 5.

The imaging device 10 images in front of the vehicle, and includes an imaging unit (omitted from the drawings) configured by a single-lens camera that generates an image signal of an image, an A/D converter unit (omitted from the drawings) that A/D converts the image generated by the imaging unit, and image memory (omitted from the drawings) for temporarily storing the A/D converted image signal.

The vehicle speed sensor 12 detects the vehicle speed of the vehicle.

The steering angle sensor 14 detects the actual steering angle of the front wheels of the vehicle.

The output device 92 displays information on the windshield of the vehicle.

The operation unit 20 is configured including a marker presentation unit 30, and a gear ratio adjusting unit 60.

The marker presentation unit 30 superimposes on the windshield of the vehicle a marker indicating the target waypoint after the forward gaze time, based on an image of in front of the vehicle input from the imaging device 10, the vehicle speed v of the vehicle input from the vehicle speed sensor 12, and the actual steering angle of the front wheels of the vehicle (a front wheels actual steering angle δ_{f}) input from the steering angle sensor 14. The marker presentation unit 30 also controls the vehicle so as to move toward the target waypoint. The marker presentation unit 30 includes an image input unit 32, a target waypoint angle detection unit 34, a marker presentation position calculation unit 36, a target yaw angular velocity calculation unit 38, and a steering management unit 40. The target waypoint angle detection unit is an example of an arrival location prediction unit.

The image input unit 32 receives the image input from the imaging device 10 of in front of the vehicle.

The target waypoint angle detection unit 34 detects the angle θ_{gaze} formed between the travelling direction of the vehicle and the direction of the target waypoint after the forward gaze time, based on the image of in front of the vehicle received by the image input unit 32, the vehicle speed v of the vehicle detected by the vehicle speed sensor 12, and the front wheel actual steering angle δ_{f} detected by the steering angle sensor 14. More specifically, first, the target waypoint angle detection unit 34 calculates the vehicle body slip angle β according to Equation (21) below, based on the vehicle speed v detected by the vehicle speed sensor 12 and the front wheel actual steering angle δ_{f} detected by the steering angle sensor 14.

$$β = \frac{{b}_{1} \cdot s + {b}_{0}}{{s}^{2} + {a}_{1} \cdot s + {a}_{0}} {δ}_{f} \\ wherein \\ {a}_{0} = \frac{4 {l}^{2} {c}_{f} {c}_{r} - 2 {mv}^{2} ( {l}_{f} {c}_{f} - {l}_{r} {c}_{r} )}{m {v}^{2} {I}_{z}} \\ {a}_{1} = \frac{2 {I}_{z} ( {c}_{f} - {c}_{r} ) + 2 m ( {l}_{f}^{2} {c}_{f} - {l}_{r}^{2} {c}_{r} )}{m v {I}_{z}} \\ {b}_{0} = \frac{2 {c}_{f} ( 2 {ll}_{r} {c}_{r} - m {v}^{2} {l}_{f} ) {c}_{r}}{m {v}^{2} {I}_{z}} \\ {b}_{1} = \frac{2 {c}_{f}}{mv} \qquad ( 21 )$$

Herein, v represents the detected vehicle speed. Moreover, l represents a predetermined wheelbase. Moreover, l_{f} represents a predetermined distance from the front axle to the center of gravity. Moreover, lᵣ represents a predetermined distance from the rear axle to the center of gravity. Moreover, m represents a predetermined vehicle mass. Moreover, I_{z} represents a predetermined yaw moment of inertia. Moreover, c_{f} represents a predetermined front wheel cornering power. Moreover, s represents a predetermined Laplace operator.

Next, the target waypoint angle detection unit 34 confirms the target course from the forward image based on image recognition processing, and detects, as the target waypoint after the forward gaze time, a point that is on the target course and that is in front of the forward gaze distance obtained by the product of the predetermined forward gaze time T_{gaze} and the vehicle speed v. Next, the target waypoint angle detection unit 34 detects the variation angle θ_{gaze} formed between the travelling direction of the vehicle and the direction of the target waypoint after the forward gaze time based on the calculated vehicle body slip angle β and the detected position of the target waypoint after the forward gaze time. Note that for the given target waypoint, the target waypoint angle detection unit 34 may be configured to acquire the target course of the vehicle from a navigation system or the like, and to detect the position of the target waypoint. Moreover, explanation has been given of an example in which the target waypoint angle detection unit 34 calculates the vehicle body slip angle β using the vehicle speed v detected by the vehicle speed sensor 12 and the front wheel actual steering angle δ_{f} detected by the steering angle sensor 14; however, there is no limitation thereto, and the target waypoint angle detection unit 34 may find the vehicle body slip angle β using another conventionally known method.

The marker presentation position calculation unit 36 determines the position to present the marker on the windshield of the vehicle based on the target waypoint after the forward gaze time T_{gaze}. More specifically, the marker presentation position calculation unit 36 determines the marker presentation position as a point of intersection between a line segment connecting the driver's viewpoint position to the target waypoint, and the plane of the windshield, based a predetermined driver's viewpoint position and predetermined position coordinates on the windshield of the vehicle. The marker presentation position calculation unit 36 outputs the determined marker presentation position to the output device 92. Note that the output device and the marker presentation position calculation unit are an example of a presentation unit.

The output device 92 displays the marker on the windshield of the vehicle based on the marker presentation position input from the marker presentation position calculation unit 36.

According to Equation (1), the target yaw angular velocity calculation unit 38 calculates the target value of the yaw angular velocity after the dead time, based the angle θ_{gaze} formed between the travelling direction of the vehicle detected by the target waypoint angle detection unit 34 and the direction of the target waypoint after the forward gaze time.

The steering management unit 40 calculates the front wheel actual steering angle δ_{f} after the dead time according to Equation (27), based on a target value r₀ of the yaw angular velocity after the dead time calculated by the target yaw angular velocity calculation unit 38, and stores the front wheel actual steering angle δ_{f} in a memory (omitted from the drawings). The relationship expressed by Equation (22) below is established between the front wheel actual steering angle δ_{f} and the yaw angular velocity r.

$$\begin{matrix}r = \frac{{b}_{4} \cdot s + {b}_{3}}{{s}^{2} + {a}_{1} \cdot s + {a}_{0}} {δ}_{f} \\ wherein & ( 22 ) \\ {b}_{3} = \frac{4 {lc}_{f} {c}_{r}}{m {vI}_{z}} & ( 23 ) \\ {b}_{4} = \frac{2 {l}_{f} {c}_{f}}{{I}_{z}} & ( 24 )\end{matrix}$$

In the first exemplary embodiment, Equation (22) to Equation (24) above are approximated as Equation (25).

r=G·e^{-Ls}·δ_{f} (25)

Herein, G represents the steady gain of Equation (22), and is expressed by Equation (26) below. Moreover, L is a dead time approximating to the dead time of delay due to the dynamic characteristics of Equation (22)

$$G = \frac{2 l {vc}_{f} {c}_{r}}{2 {l}^{2} {c}_{f} {c}_{r} - {mv}^{2} ( {l}_{f} {c}_{f} - {l}_{r} {c}_{r} )} \qquad ( 26 )$$

The front wheel actual steering angle δ_{f} for implementing the target value r₀ of the yaw angular velocity after the dead time τ is accordingly calculated according to Equation (27) below.

$${δ}_{f} ( t + τ - L ) = \frac{1}{G} \cdot {r}_{0} = \{ \frac{l}{v} - \frac{m ( {l}_{f} {c}_{f} - {l}_{r} {c}_{r} )}{2 l {c}_{f} {c}_{r}} \} {r}_{0} ( t + τ ) \qquad ( 27 )$$

Note that in consideration of delay in vehicle motion, a value from which dead time L of Equation (25) has been subtracted is employed as the dead time. When the dead time has elapsed, the steering management unit 40 reads the corresponding front wheel actual steering angle δ_{f} from the memory, and, based on the read front wheel actual steering angle δ_{f} detected by the steering angle sensor 14 and the read steering angle δ_{f}, calculates a steering assist torque needed to obtain the read front wheel actual steering angle δ_{f}. Moreover, the steering management unit 40 performs setting so as to add the calculated steering assist torque to an assist torque in an electric power steering device of the steering device 90. The target value r₀ of the yaw angular velocity is thereby achieved by the steering device 90.

The gear ratio adjusting unit 60 controls the steering gear ratio of the vehicle based on the vehicle speed detected by the vehicle speed sensor 12. Moreover, the gear ratio adjusting unit 60 includes a map storage unit 70, a yaw gain calculation unit 72, a gear ratio calculation unit 74, and a gear ratio control unit 76. Note that the yaw gain calculation unit 72 is an example of a yaw angular velocity gain calculation unit.

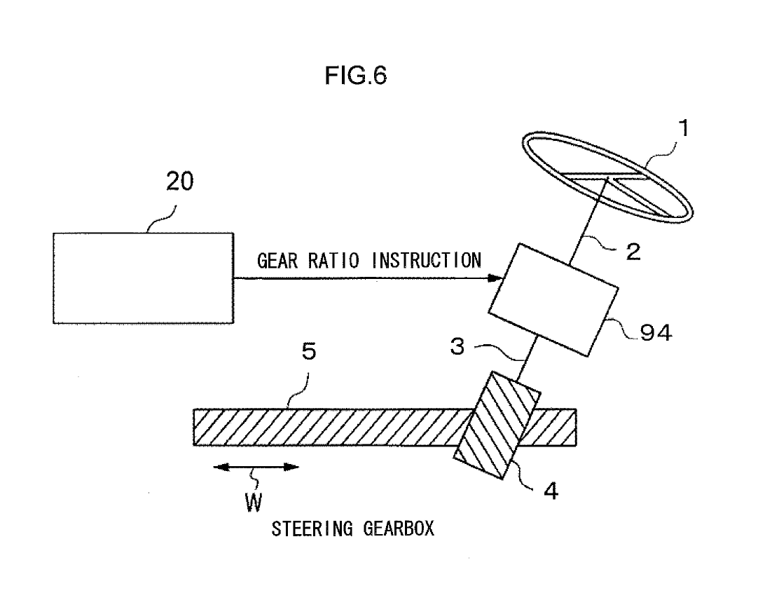

As illustrated in FIG. 6, the gear ratio adjusting unit 60 is connected to the steering gear ratio changing unit 94 that is connected to a turning axle 2 coupled to a steering wheel 1. An output axle 3 projects from the steering gear ratio changing unit 94, and a pinion 4 interlocked with the output axle 3 enmeshes with a rack axle 5 connected to the wheels to be steered, omitted from the drawings.

Rotation of the steering wheel 1 is thereby transmitted through the steering gear ratio changing unit 94 to the pinion 4, and the wheels to be steered are steered by the rack axle 5 moving along the axial direction of the rack axle 5 (the arrow Win FIG. 6).

The steering gear ratio changing unit 94 is connected to the operation unit 20. The steering gear ratio changing unit 94 is configured such that the steering gear ratio of the steering gear ratio changing unit 94 changes based on a gear ratio command signal output from the operation unit 20. Note that the steering gear ratio changing unit 94 may have a previously known structure.

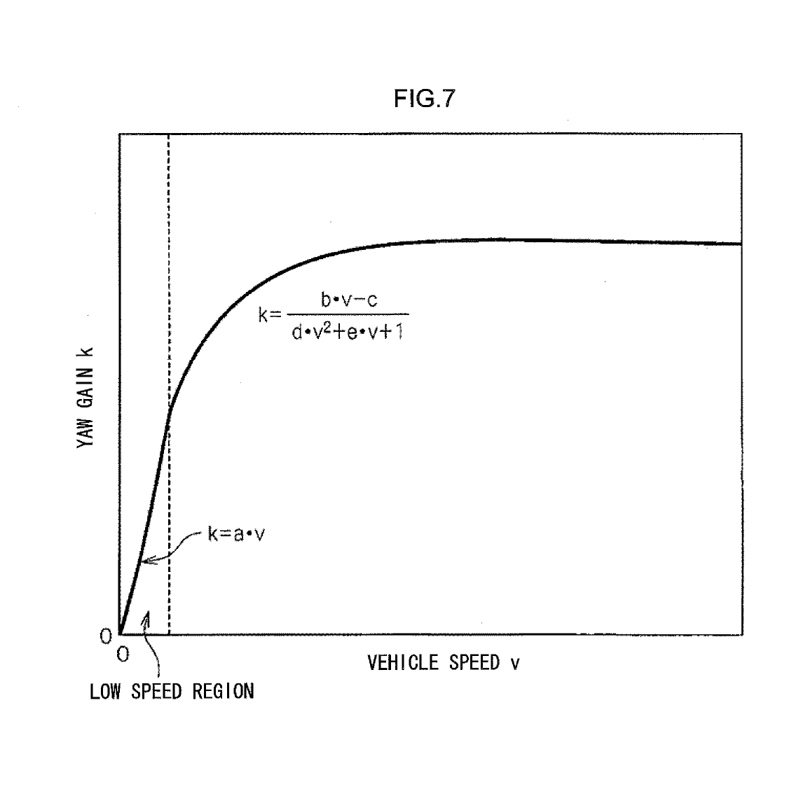

A predetermined map is stored in the map storage unit 70 to represent a relationship between the yaw angular velocity gain k that is a ratio between the yaw angular velocity and the steering wheel angle (the yaw angular velocity to obtain the yaw angular velocity from the steering wheel angle), and the vehicle speed v. The map is derived by calculating the yaw angular velocity gain in the vehicle speed region in which the forward gaze point is present above the cut-off line of the driver's forward field of view based on Equation (16), and by calculating the yaw angular velocity gain in a vehicle speed region below the above-mentioned vehicle speed region based on Equation (20). A map like that of FIG. 7 indicating a relationship between the yaw angular velocity gain k, and the vehicle speed v is thereby obtained. Note that simplified notations of Equation (16) and Equation (20) are indicated as the vehicle speed in FIG. 7.

The yaw gain calculation unit 72 calculates the target value of the yaw angular velocity gain k that corresponds to the vehicle speed detected by the vehicle speed sensor 12 according to the map stored in the map storage unit 70.

Next, explanation follows regarding a control method for achieving the yaw angular velocity gain k that is the target calculated based on the map.

The yaw angular velocity gain k that is the target is achieved by actively changing the characteristics of the steering gear ratio changing unit 94 provided between the steering wheel and the mechanism that steers the actual steering angle of the front wheels according to the vehicle speed v. The relationship expressed by Equation (28) is established between the front wheel actual steering angle δ_{f} and the yaw angular velocity r when dynamic characteristics of vehicle motion are ignored.

$$r = \frac{v}{l - \frac{{l}_{f} {C}_{f} - {l}_{r} {C}_{r}}{2 {lC}_{f} {C}_{r}} {mv}^{2}} \cdot {δ}_{f} \qquad ( 28 )$$

Herein, C_{f} is a predetermined front wheel cornering power. The relationship expressed by Equation (29) below is obtained when g_{sw} is taken as the steering gear ratio between the steering wheel angle δ_{sw} and the front wheel actual steering angle δ_{f}.

δ_{sw}=g_{sw}·δ_{f} (29)

According to Equation (28) and Equation (29), the steering gear ratio g_{sw} for realizing the yaw angular velocity gain k calculated from the map illustrated in FIG. 7 is expressed by Equation (30) below.

$${g}_{sw} = \frac{v}{l - \frac{{l}_{f} {C}_{f} - {l}_{r} {C}_{r}}{2 {lC}_{f} {C}_{r}} {mv}^{2}} \cdot \frac{1}{k} \qquad ( 30 )$$

wherein, in the case that

$$v < \frac{{h}_{eye}}{{T}_{gaze} \cdot {θ}_{zfview}} ,$$

On the other hand, in the case that

$$k = \frac{{θ}_{zsw} - {θ}_{zfview}}{\frac{{L}_{fview}}{2} + {l}_{r}} \cdot v .$$

The gear ratio calculation unit 74 calculates the steering gear ratio g_{sw} according to Equation (30), based on the target yaw angular velocity gain k calculated by the yaw gain calculation unit 72 and the vehicle speed v detected by the vehicle speed sensor 12.

The gear ratio control unit 76 outputs the gear ratio command signal to the steering gear ratio changing unit 94 so as to change to the calculated steering gear ratio g_{sw}, and controls the steering gear ratio g_{sw}. The gear ratio control unit is an example of a control unit.

Operation of Marker Presentation Processing of Predicted Arrival Point Presentation Device According to the First Exemplary Embodiment of the Present Invention

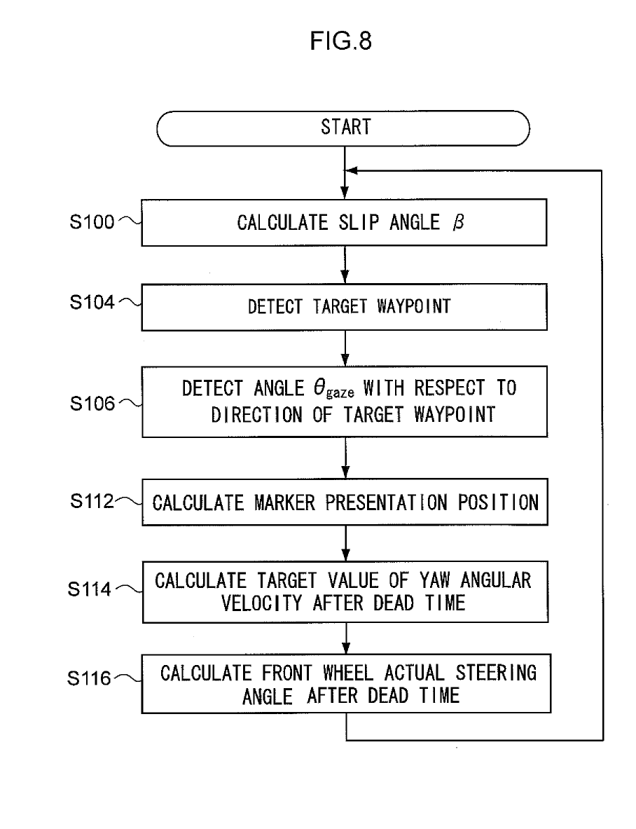

Next, explanation follows regarding operation of marker presentation processing of the predicted arrival point presentation device 100 according to the first exemplary embodiment of the present invention. First, the image of in front of the vehicle, the vehicle speed v of the vehicle, and the front wheel actual steering angle δ_{f} of the vehicle are received from the imaging device 10, the vehicle speed sensor 12, and the steering angle sensor 14 while the vehicle installed with the predicted arrival point presentation device 100 is travelling, and the marker presentation processing routine illustrated in FIG. 8 is executed by the predicted arrival point presentation device 100.

First, at step S100, the target waypoint angle detection unit 34 calculates the vehicle body slip angle β according to Equation (21), based on the received vehicle speed v and the front wheel actual steering angle δ_{f}.

Next, at step S104, the target waypoint angle detection unit 34 recognizes the target course by using image recognition processing on the received front image, and detects a point that is on the target course and in front of the forward gaze distance obtained from the product of the predetermined forward gaze time T_{gaze} and the vehicle speed v as the target waypoint after forward gaze time T_{gaze}.

Next, at step S106, the target waypoint angle detection unit 34 detects the angle θ_{gaze} formed between the travelling direction of the vehicle and the direction of the target waypoint after the forward gaze time T_{gaze}, based on the vehicle body slip angle β acquired at step S100 and the position of the target waypoint acquired at step S104.

Next, at step S112, the marker presentation position calculation unit 36 calculates the marker presentation position based on the target waypoint after the forward gaze time acquired at step S104, and outputs a marker presentation instruction to the output device 92.

Next, at step S114, the target yaw angular velocity calculation unit 38 calculates the target value r₀ of the yaw angular velocity after the dead time based on the angle θ_{gaze} formed between the travelling direction of vehicle and the direction of the target waypoint after the forward gaze time acquired at step S106.

Next, at step S116, steering management unit 40 calculates the front wheel actual steering angle δ_{f} to achieve the target value r₀ of the yaw angular velocity after the dead time acquired at step S114 according to Equation (27). Moreover, the steering management unit 40 sets a timing after the dead time as a specified timing, and stores the calculated front wheel actual steering angle δ_{f} in the memory. The predicted arrival point presentation device 100 then receives the new image of in front of the vehicle, vehicle speed v of the vehicle, and front wheel actual steering angle δ_{f} of the vehicle from the imaging device 10, the vehicle speed sensor 12, and the steering angle sensor 14, and the marker presentation processing routine transitions to step S100.

The processing below is then executed by the output device 92.

First, the output device 92 identifies the position to present the mark on the windshield of the vehicle as input from the marker presentation position calculation unit 36. The output device 92 then presents the marker at the identified position.

By repeatedly executing the above processing, the marker can be continuously presented at a repeatedly calculated marker presentation position.

Moreover, the processing below is executed by the steering management unit 40 in the operation unit 20.

First, the steering management unit 40 reads from the memory the front wheel actual steering angle δ_{f} set with the current time as a specified item. The steering management unit 40 also calculates the steering assist torque to achieve the front wheel actual steering angle δ_{f}. The steering management unit 40 controls the steering device 90 so as to set additional assist torque in the electric power steering device of the steering device 90.

Each of the repeatedly calculated target values r₀ of the yaw angular velocity after the dead time can be achieved by repeatedly executing the processing above.

Operation of Gear Ratio Adjustment Processing of the Predicted Arrival Point Presentation Device according to the First Exemplary Embodiment of the Present Invention

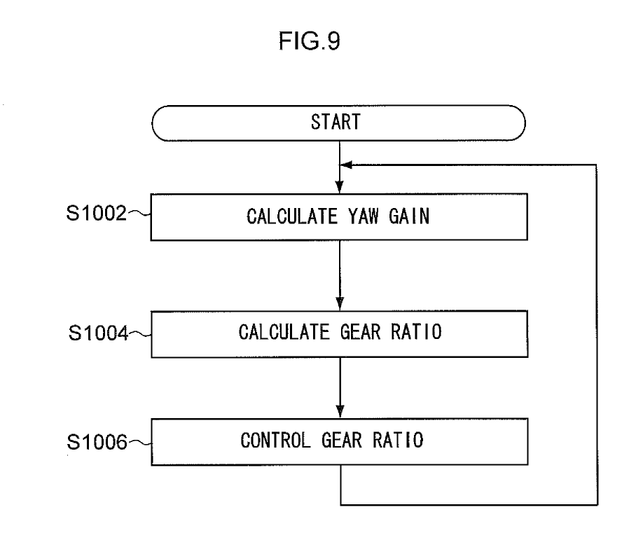

Next, explanation follows regarding operation of gear ratio adjustment processing of the predicted arrival point presentation device 100 according to the first exemplary embodiment of the present invention. First, when the vehicle speed of the vehicle is received from the vehicle speed sensor 12 while the vehicle installed with the predicted arrival point presentation device 100 is travelling, and the gear ratio adjustment processing routine illustrated in FIG. 9 is executed by the predicted arrival point presentation device 100.

First, at step S1002, the yaw gain calculation unit 72 calculates the target value of the yaw angular velocity gain k from the received vehicle speed v, according to the received vehicle speed v of the vehicle, and the map stored in the map storage unit 70.

Next, at step S1004, the gear ratio calculation unit 74 calculates, according to Equation (30), the steering gear ratio g_{sw} to achieve the target value of the yaw angular velocity gain k from the received vehicle speed v of the vehicle and the target value of the yaw angular velocity gain k acquired at step S1002.

Next, at step S1006, the gear ratio control unit 76 outputs the gear ratio instruction signal to the steering gear ratio changing unit 94 so as to change to the steering gear ratio g_{sw} acquired at step S1004. The gear ratio control unit 76 controls the steering gear ratio g_{sw} and receives a new vehicle speed v for the vehicle from the vehicle speed sensor 12, and processing returns to step S1002.

Repeatedly executing the above processing successively achieves the repeatedly calculated target value of the yaw angular velocity gain k.

As explained above, for a vehicle travelling along a route under driving assistance, the predicted arrival point presentation device according to the first exemplary embodiment of the present invention predicts the location at which the vehicle will arrive after a forward gaze time of a driver based on the actual front wheel steering angle and the vehicle speed. The predicted arrival point can thereby be presented to the driver with high precision by presenting a marker indicating the predicted location of arrival at a position on the windshield of the vehicle.

This thereby enables the driver to be made aware of the arrival point of the vehicle after a fixed time (gaze time) through both the presented predicted arrival point and the direction of the steering wheel. Moreover, the presented predicted arrival point also has the effect of guiding the driver's line of sight. Gaze times that vary greatly depending on the individual can be controlled to an ideal state. Controlling the driver's gaze time to a constant value therefore enables the vehicle motion when the driver is driving to be matched with the vehicle motion achieved by control by the driving assistance system, and enables a smooth transition of responsibility from the driving assistance system to the driver.

Note that the present invention is not limited to the above embodiment, and various modifications and applications may be made within a range not exceeding the spirit of the present invention.

For example, although explanation has been given of a case in which the front wheel actual steering angle of the vehicle is detected using a steering angle sensor in the first exemplary embodiment, there is no limitation thereto. For example, the steering wheel angle of the vehicle may be detected by a sensor. In such cases, the product of the steering wheel angle and the steering gear ratio may be calculated as the front wheel actual steering angle.

Moreover, although explanation has been given of a case in which the sight line position of the driver is fixed, there is no limitation thereto. For example, the driver's sight line position may be acquired by a camera or the like.

Next, explanation follows regarding a predicted arrival point presentation device according to a second exemplary embodiment. Note that that same reference numerals are allocated to parts of configuration similar to in the first exemplary embodiment.

The second exemplary embodiment mainly differs from the first exemplary embodiment in the calculation of the target value of the yaw angular velocity and in control of the steering gear ratio so as to achieve the target value of the yaw angular velocity in the gear ratio adjusting unit.

Configuration of a Predicted Arrival Point Presentation Device According to the Second Exemplary Embodiment of the Present Invention

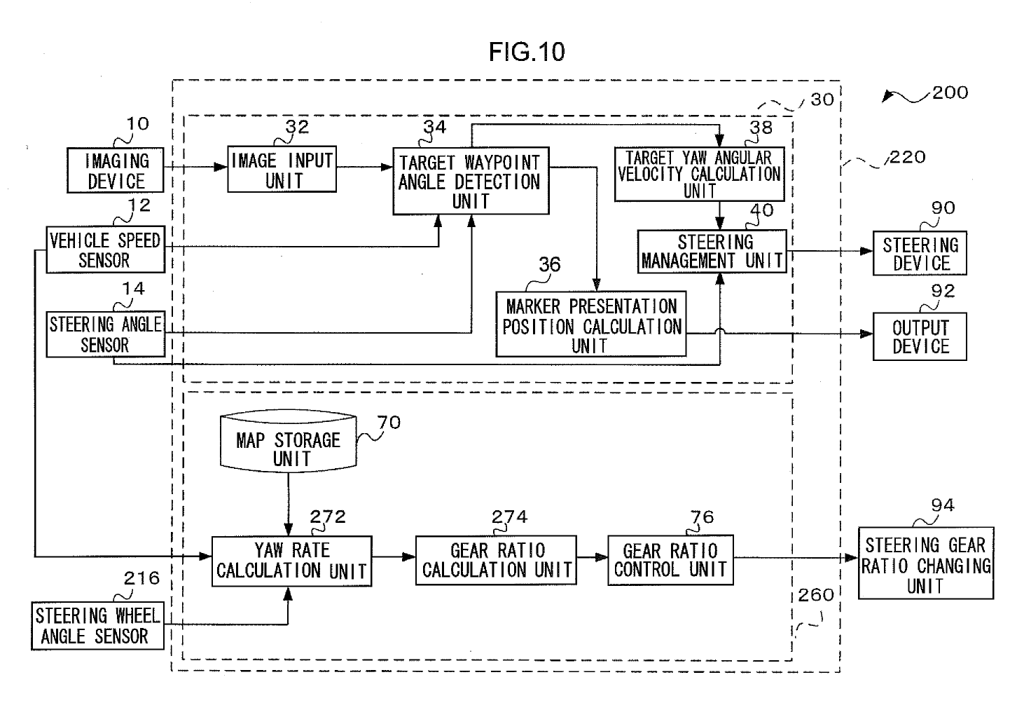

Next, explanation follows regarding configuration of a predicted arrival point presentation device 200 according to the second exemplary embodiment of the present invention. As illustrated in FIG. 10, the predicted arrival point presentation device 200 according to the second exemplary embodiment of the present invention can be configured by a computer including a CPU, RAM, and ROM stored with programs and various data for executing a gear ratio control processing routine and a marker presentation processing routine described later. The predicted arrival point presentation device 200 includes an imaging device 10, a vehicle speed sensor 12, a steering angle sensor 14, a steering wheel angle sensor 216, an operation unit 220, a steering device 90, an output device 92, and a steering gear ratio changing unit 94 as functionally illustrated in FIG. 10.

The steering wheel angle sensor 216 detects the steering wheel angle δ_{sw} of the vehicle.

The operation unit 220 is configured including a marker presentation unit 30, and a gear ratio adjusting unit 260.

The gear ratio adjusting unit 260 controls the steering gear ratio of the vehicle based on the vehicle speed v of the vehicle detected by the vehicle speed sensor 12 and the steering wheel angle δ_{sw} of the vehicle detected by the steering wheel angle sensor 216. Moreover, the gear ratio adjusting unit 260 includes a map storage unit 70, a yaw rate calculation unit 272, a gear ratio calculation unit 274, and a gear ratio control unit 76.

The yaw rate calculation unit 272 calculates a yaw angular velocity gain corresponding to the vehicle speed v of the vehicle detected by the vehicle speed sensor 12 according to a map recorded in the map storage unit 70. The yaw rate calculation unit 272 calculates a target value for the yaw angular velocity based on the calculated yaw angular velocity gain and the steering wheel angle detected by the steering wheel angle sensor 216. The yaw rate calculation unit 272 is an example of a yaw angular velocity calculation unit.

According to Equation (28), the gear ratio calculation unit 274 calculates a front wheel actual steering angle δ_{f} to achieve the yaw angular velocity r set as the target based on the yaw angular velocity r calculated as the target by the yaw rate calculation unit 272 and on the vehicle speed v detected by the vehicle speed sensor 12. According to Equation (29), the gear ratio calculation unit 274 calculates a steering gear ratio g_{sw} based on the calculated front wheel actual steering angle δ_{f} and the steering wheel angle δ_{sw} detected by the steering wheel angle sensor 216.

Operation of the Gear Ratio Adjustment Processing of the Predicted Arrival Point Presentation Device According to the Second Exemplary Embodiment of the Present Invention

Next, explanation follows regarding operation of the gear ratio adjustment processing of the predicted arrival point presentation device 200 according to the second exemplary embodiment of the present invention. First, the predicted arrival point presentation device 200 acquires both the vehicle speed v detected by the vehicle speed sensor 12 and the steering wheel angle δ_{sw} detected by the steering wheel angle sensor 216. The predicted arrival point presentation device 200 then calculates the target value of the yaw angular velocity r from the vehicle speed v and the steering wheel angle δ_{sw} acquired above, according to the map stored in the map storage unit 70.

Next, according to Equation (28) and Equation (29), the predicted arrival point presentation device 200 calculates the steering gear ratio g_{sw} to achieve the target value of the yaw angular velocity from the vehicle speed v acquired above and the target value of the yaw angular velocity r calculated above. The predicted arrival point presentation device 200 then controls the steering gear ratio g_{sw} by outputting the gear ratio instruction signal to the steering gear ratio changing unit 94 so as to change to the steering gear ratio g_{sw} calculated above, and the gear ratio adjustment processing routine returns to the initial processing.

Repeatedly executing the above processing achieves each of the repeatedly calculated target values of the yaw angular velocity r.

As explained above, for a vehicle travelling along a route under driving assistance, the predicted arrival point presentation device according to the second exemplary embodiment of the present invention predicts the location at which the vehicle will arrive after the forward gaze time of the driver based on the steering wheel angle and the vehicle speed. The predicted arrival point can thereby be presented to the driver with high precision by presenting a marker indicating the predicted location of arrival at a position on the windshield of the vehicle.

Next, explanation follows regarding a predicted arrival point presentation device according to a third exemplary embodiment. Note that that same reference numerals are allocated to parts of configuration similar to in the first exemplary embodiment.

The third exemplary embodiment mainly differs from the first exemplary embodiment in that corrective steering of the steering wheel by the driver is detected using a torque sensor added to the steering wheel and in marker presentation according to the correct steering.

Configuration of a Predicted Arrival Point Presentation Device According to the Third Exemplary Embodiment of the Present Invention

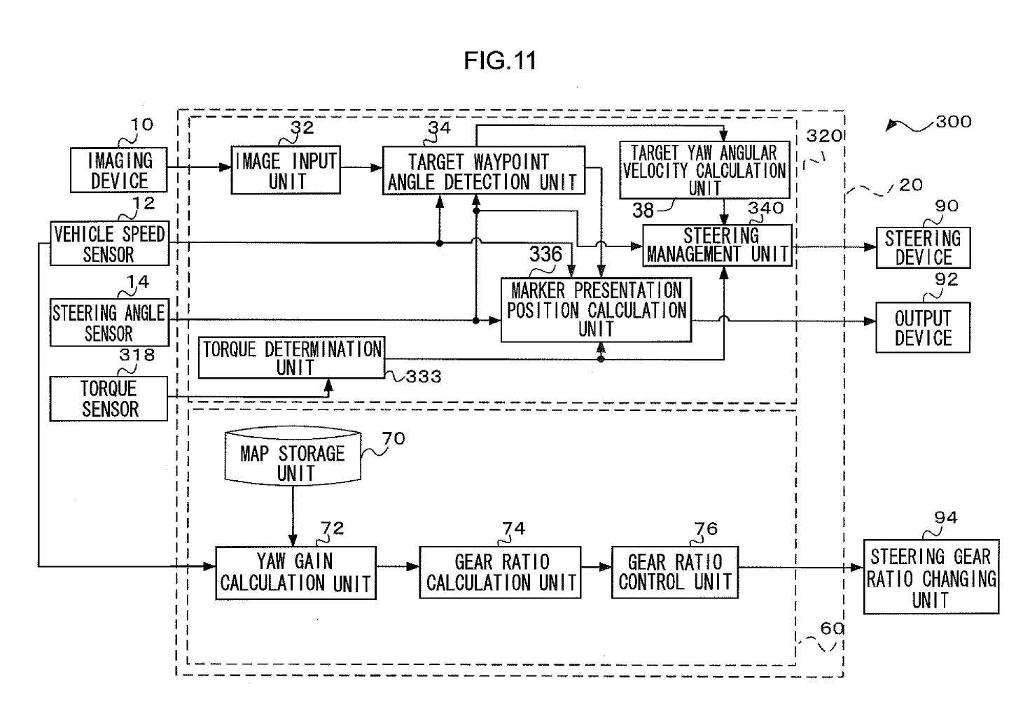

Next, explanation follows regarding configuration of a predicted arrival point presentation device 300 according to the third exemplary embodiment of the present invention. As illustrated in FIG. 11, the predicted arrival point presentation device 300 according to the third exemplary embodiment of the present invention can be configured by a computer including a CPU, RAM, and ROM stored with programs and various data for executing a gear ratio control processing routine and a marker presentation processing routine, described later. The predicted arrival point presentation device 300 includes an imaging device 10, a vehicle speed sensor 12, a steering angle sensor 14, a torque sensor 318, an operation unit 320, a steering device 90, an output device 92, and a steering gear ratio changing unit 94 as functionally illustrated in FIG. 11.

The torque sensor 318 detects torque imparted to the steering wheel of the vehicle.

The operation unit 20 is configured including a marker presentation unit 330, and a gear ratio adjusting unit 60.

The marker presentation unit 330 superimposes on the windshield of the vehicle a marker indicating the target waypoint after the forward gaze time, based on an image of in front of the vehicle input from the imaging device 10, the vehicle speed v of the vehicle input from the vehicle speed sensor 12, the front wheels actual steering angle δ_{f} of the vehicle input from the steering angle sensor 14, and the torque input from the torque sensor 318. The marker presentation unit 330 also controls the vehicle so as to move to the target waypoint. The marker presentation unit 330 includes an image input unit 32, a torque determination unit 333, a target waypoint angle detection unit 34, a marker presentation position calculation unit 336, a target yaw angular velocity calculation unit 38, and a steering management unit 340.

The torque determination unit 333 determines whether or not the driver has performed active corrective steering, based on the torque detected by the torque sensor 318. The torque determination unit 333 can determine whether or not the driver performed active corrective steering from torque imparted to the steering wheel. Namely, a threshold value exists in the characteristics of steering wheel steering performed by human inclination, and the torque determination unit 333 can determine that active corrective steering has been performed when torque exceeding this threshold is imparted. Specifically, the torque determination unit 333 determines whether or not the driver performed active corrective steering based on whether or not torque detected by the torque sensor 318 has exceeded a predetermined threshold value. In the third exemplary embodiment, the threshold value is, for example, set to from 1 Nm to 1.5 Nm, and the torque determination unit 333 determines that corrective steering was performed when this threshold value is exceeded.

When the torque determination unit 333 has determined that the driver did not perform active corrective steering, the marker presentation position calculation unit 336 determines the position to present the marker on the windshield of the vehicle based on the predicted arrival point, similarly to the marker presentation position calculation unit 36 explained in the first exemplary embodiment. Moreover, the marker presentation position calculation unit 336 outputs the determined position to present the marker to the output device 92.

When the torque determination unit 333 has determined that the driver performed active corrective steering, the marker presentation position calculation unit 336 calculates the yaw angular velocity r of the vehicle. Moreover, the marker presentation position calculation unit 336 determines the position to present the marker on the windshield of the vehicle based on the calculated yaw angular velocity r. Based on Equation (33) to Equation (35) below, the marker presentation position calculation unit 336 predicts the position of the vehicle after the forward gaze time, using the current position of the vehicle as a reference. Moreover, based on the predicted position of the vehicle after the forward gaze time, the predetermined driver's viewpoint position, and the predetermined position coordinates of the windshield of the vehicle, the marker presentation position calculation unit 336 determines the marker presentation position as the intersection point between a line segment connecting the eye point that is the driver's viewpoint position and the predicted arrival point, and the plane of the windshield. Moreover, the marker presentation position calculation unit 336 outputs the determined marker presentation position to the output device 92.

When the torque determination unit 333 has determined that the driver did not perform active corrective steering, the steering management unit 340 calculates the front wheel actual steering angle after the dead time, similarly to the steering management unit 40 explained in the first exemplary embodiment. The steering management unit 340 stores the calculated front wheel actual steering after the dead time in a memory (omitted from illustration). The steering management unit 340 reads the corresponding front wheel actual steering angle δ_{f} from the memory when the dead time has elapsed, and based on the read front wheel actual steering angle δ_{f}, calculates the steering assist torque necessary to achieve the read front wheel actual steering angle δ_{f}. Moreover, the steering management unit 340 performs setting such that calculated steering assist torque is added to the assist torque of the electric power steering device of the steering device 90.

Moreover, when the torque determination unit 333 has determined that the driver performed active corrective steering, the steering management unit 340 does not regulate the steering device 90.

Operation of the Marker Presentation Processing of the Predicted Arrival Point Presentation Device According to the Third Exemplary Embodiment of the Present Invention

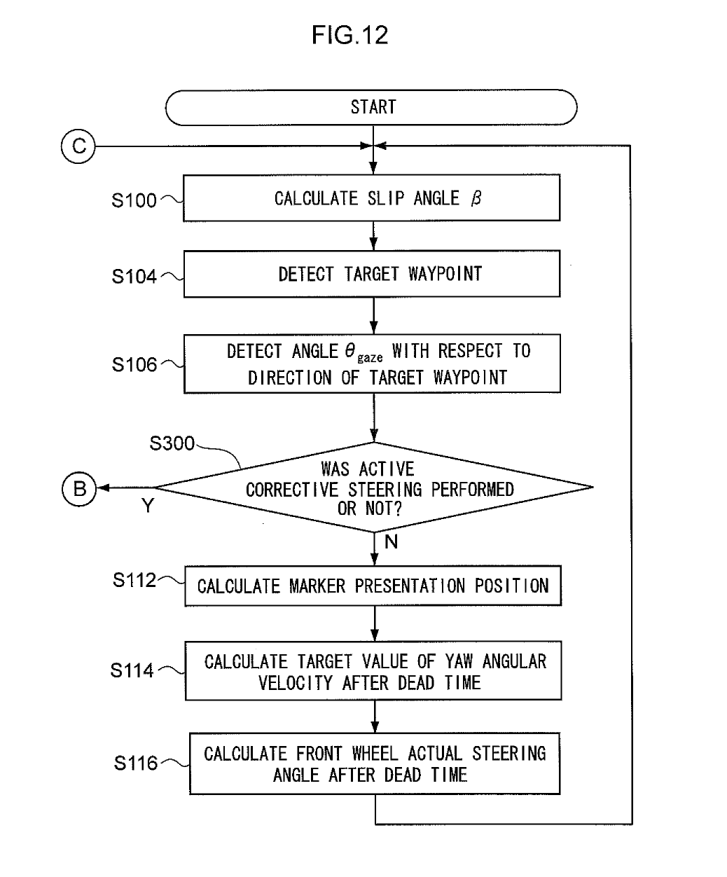

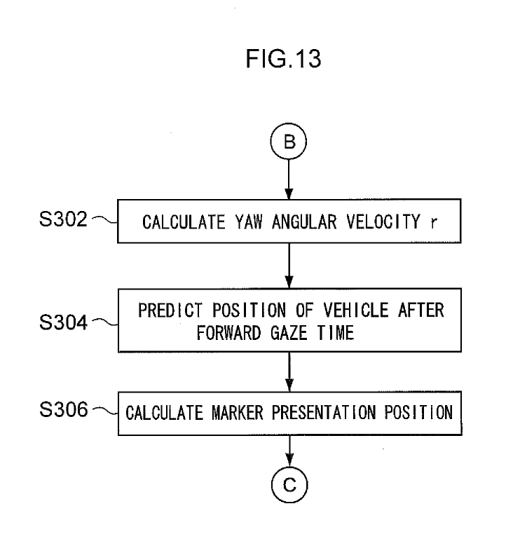

Next, explanation follows regarding operation of marker presentation processing of the predicted arrival point presentation device 300 according to the third exemplary embodiment of the present invention. First, the image of in front of the vehicle, the vehicle speed v of the vehicle, the front wheel actual steering angle δ_{f} of the vehicle, and the torque imparted to the steering wheel of the vehicle are received from the imaging device 10, the vehicle speed sensor 12, the steering angle sensor 14, and the torque sensor 318 while the vehicle installed with the predicted arrival point presentation device 300 is travelling, and the marker presentation processing routine illustrated in FIG. 12 and FIG. 13 is executed by the predicted arrival point presentation device 300.

First, at step S300, the torque determination unit 333 determines whether or not the driver performed active corrective steering based on the torque that is received from the torque sensor 318 and being imparted to the steering wheel of the vehicle. When torque determination unit 333 has determined that the driver performed active corrective steering, the marker presentation processing routine transitions to step S302. However, when the torque determination unit 333 has determined that the driver has not performed active corrective steering, the marker presentation processing routine transitions to step S100, and the processing of step S100 to step S116 is performed. The predicted arrival point presentation device 300 then receives the new image of in front of the vehicle, vehicle speed v of the vehicle, front wheel actual steering angle δ_{f} of the vehicle, and torque imparted to the steering wheel of the vehicle, from the imaging device 10, the vehicle speed sensor 12, the steering angle sensor 14, and the torque sensor 318, and the marker presentation processing routine transitions to step S300.

Next, at step S302, the marker presentation position calculation unit 336 calculates the yaw angular velocity r based on the received vehicle speed v of the vehicle and the front wheel actual steering angle δ_{f} of the vehicle.

At step S304, the marker presentation position calculation unit 336 predicts the position of the vehicle after the forward gaze time, based on the yaw angular velocity r acquired at step S302, according to Equation (33) to Equation (35).

Next, at step S306, the marker presentation position calculation unit 336 calculates the marker presentation position based on the position of the vehicle after the forward gaze time acquired at step S304 and the position coordinates on the windshield of the vehicle. Moreover, the marker presentation position calculation unit 336 outputs the marker presentation instruction to the output device 92. The predicted arrival point presentation device 300 then receives the new image of in front of the vehicle, vehicle speed v of the vehicle, front wheel actual steering angle δ_{f} of the vehicle, and torque imparted to the steering wheel of the vehicle, from the imaging device 10, the vehicle speed sensor 12, the steering angle sensor 14, and the torque sensor 318, and the marker presentation processing routine transitions to step S300.

As explained above, the predicted arrival point presentation device according to the third exemplary embodiment of the present invention, when the vehicle is travelling along the route under driving assistance, the location at which the vehicle will arrive after the driver's forward gaze time is predicted based on the steering wheel angle and the vehicle speed. The predicted arrival point can thereby be presented to the driver with high precision by presenting a marker indicating the predicted location of arrival at a position on the windshield of the vehicle.

Note that the present invention is not limited to the above embodiments. Various modifications may be applied within a range not exceeding the spirit of the present invention.

For example, explanation has been given for the third exemplary embodiment of a case in which the yaw angular velocity r is calculated when it has been determined that the driver performed active corrective steering, and the predicted arrival point is calculated based on the calculated yaw angular velocity r; however, there is no limitation thereto. For example, a yaw angle corrected based on a corrected steering angle may be calculated, and the target waypoint may be corrected by this yaw angle.

Next, explanation follows regarding a predicted arrival point presentation device according to a fourth exemplary embodiment. Note that that same reference numerals are allocated to parts of configuration similar to in the first exemplary embodiment.

The fourth exemplary embodiment mainly differs from the first exemplary embodiment with regard to determination of whether or not the predicted arrival point is to be displayed by the marker based on a change amount in the steering wheel angle δ_{sw} within a fixed time period.

Configuration of a Predicted Arrival Point Presentation Device According to the Fourth Exemplary Embodiment of the Present Invention

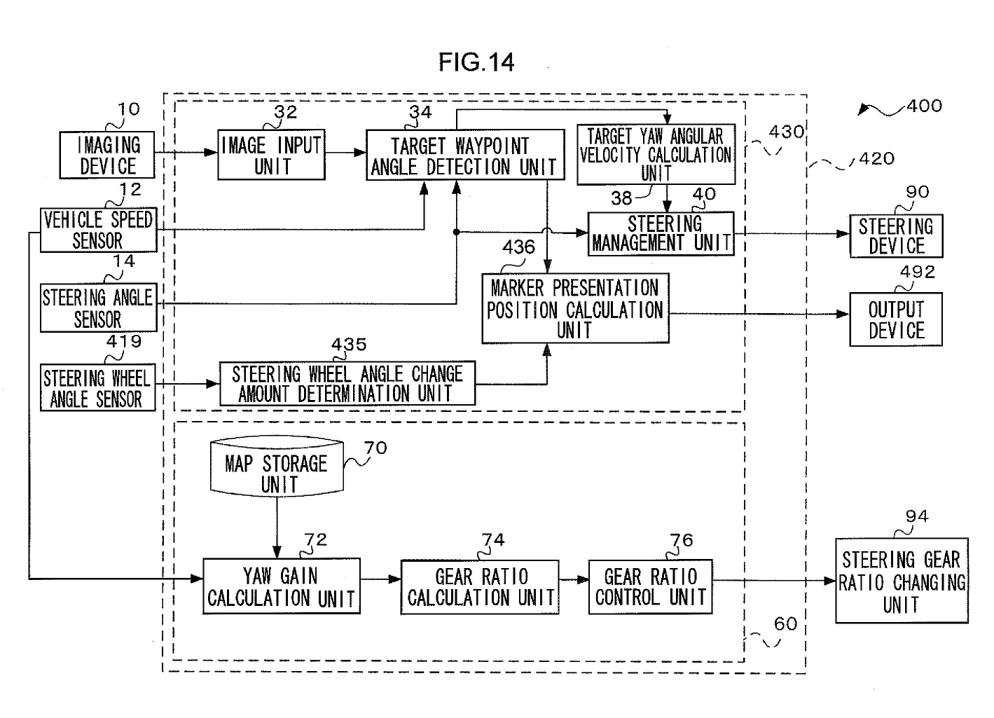

Next, explanation follows regarding configuration of a predicted arrival point presentation device 400 according to the fourth exemplary embodiment of the present invention. As illustrated in FIG. 14, the predicted arrival point presentation device 400 according to the fourth exemplary embodiment of the present invention can be configured by a computer including a CPU, RAM, and ROM stored with programs and various data for executing a gear ratio control processing routine and a marker presentation processing routine, described later. The predicted arrival point presentation device 400 includes an imaging device 10, a vehicle speed sensor 12, a steering angle sensor 14, a steering wheel angle sensor 419, an operation unit 420, a steering device 90, an output device 492, and a steering gear ratio changing unit 94 as functionally illustrated in FIG. 14.

The steering wheel angle sensor 419 detects the steering wheel angle δ_{sw} of the vehicle.

The operation unit 420 is configured including a marker presentation unit 430, and a gear ratio adjusting unit 60.

The marker presentation unit 430 superimposes on the windshield of the vehicle a marker indicating the target waypoint after the forward gaze time, based on an image of in front of the vehicle input from the imaging device 10, the vehicle speed v of the vehicle input from the vehicle speed sensor 12, the front wheels actual steering angle δ_{f} of the vehicle input from the steering angle sensor 14, and the steering wheel angle δ_{sw} input from the steering wheel angle sensor 419. The marker presentation unit 430 also controls the vehicle so as to move to the target waypoint. The marker presentation unit 430 includes an image input unit 32, a target waypoint angle detection unit 34, a steering wheel angle change amount determination unit 435, a marker presentation position calculation unit 436, a target yaw angular velocity calculation unit 38, and a steering management unit 40.

The steering wheel angle change amount determination unit 435 determines whether or not the change amount in the steering wheel angle δ_{sw} detected by the steering wheel angle sensor 419 exceeded a predetermined reference value within a fixed time period (within the dead time). When the change amount in the steering wheel angle δ_{sw} has exceeded the predetermined reference value within the fixed time period, the steering wheel angle change amount determination unit 435 then outputs an instruction to not present the marker to the marker presentation position calculation unit 436. However, when the change amount in the steering wheel angle δ_{sw} has not exceeded the predetermined reference value within the fixed time period, the steering wheel angle change amount determination unit 435 outputs an instruction to the marker presentation position calculation unit 436 to present the marker.

When the steering wheel angle change amount determination unit 435 has determined that the change amount in the steering wheel angle δ_{sw} has not exceeded the predetermined reference value within the fixed time period, the marker presentation position calculation unit 436 determines the position to present the marker on the windshield of the vehicle based on the θ_{gaze} detected by the target waypoint angle detection unit 34, similarly to the marker presentation position calculation unit 36 explained in the first exemplary embodiment. The marker presentation position calculation unit 436 outputs the determined position to present the marker to the output device 492.

When the steering wheel angle change amount determination unit 435 has determined that the change amount in the steering wheel angle δ_{sw} has exceeded the predetermined reference value within the fixed time period, the marker presentation position calculation unit 436 outputs an instruction to the output device 492 not to output the mark.

Operation of the Marker Presentation Processing of the Predicted Arrival Point Presentation Device According to the Fourth Exemplary Embodiment of the Present Invention

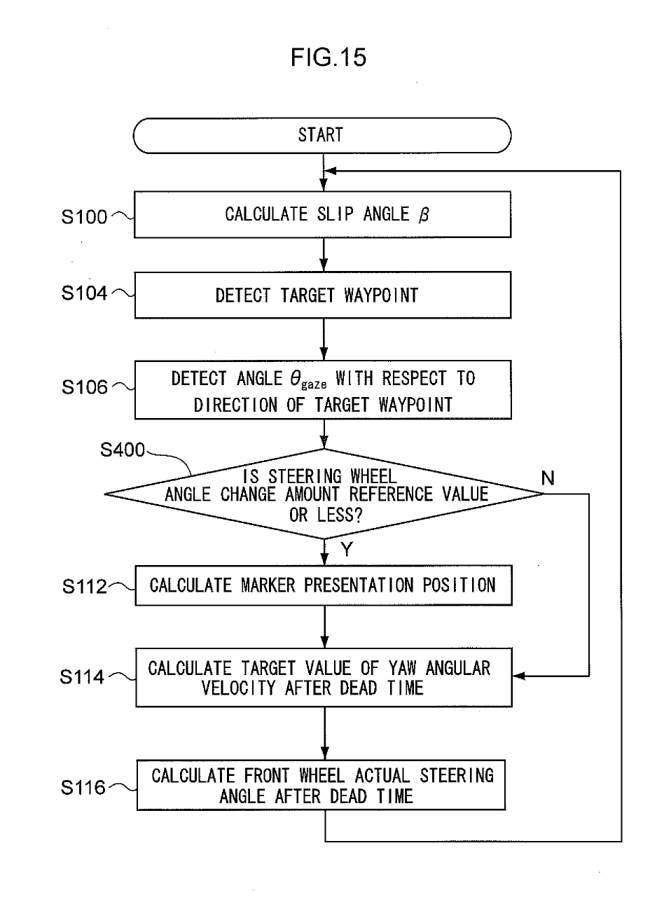

Next, explanation follows regarding operation of marker presentation processing of the predicted arrival point presentation device 400 according to the fourth exemplary embodiment of the present invention. First, the image of in front of the vehicle, the vehicle speed v of the vehicle, the front wheel actual steering angle δ_{f} of the vehicle, and the steering wheel angle δ_{sw} of the vehicle are received from the imaging device 10, the vehicle speed sensor 12, the steering angle sensor 14, and the steering wheel angle sensor 419 while the vehicle installed with the predicted arrival point presentation device 400 is travelling, and the marker presentation processing routine illustrated in FIG. 15 is executed by the predicted arrival point presentation device 400.

At step S400, the steering wheel angle change amount determination unit 435 determines whether or not the change amount in the steering wheel angle δ_{sw} within the fixed time period is the predetermined reference value or less based on the steering wheel angle δ_{sw} of the vehicle received from the steering wheel angle sensor 419. When the steering wheel angle change amount determination unit 435 has determined that the change amount of the steering wheel angle δ_{sw} within the fixed time period is greater than the predetermined reference value, the marker presentation processing routine transitions to step S114. However, when the steering wheel angle change amount determination unit 435 has determined that the change amount in the steering wheel angle δ_{sw} was the predetermined threshold value or less within the fixed time period, the marker presentation processing routine transitions to step S112.

As explained above, in the predicted arrival point presentation device according to the fourth exemplary embodiment of the present invention, when the vehicle is travelling along the route under driving assistance, the location at which the vehicle will arrive after the driver's forward gaze time is predicted based on the steering wheel angle δ_{sw} and the vehicle speed v. The predicted arrival point can thereby be presented to the driver with high precision by presenting a marker indicating the predicted location of arrival at a position on the windshield of the vehicle.

Sometimes a point separated from the original predicted arrival point is indicated when the relationship equation derived by disregarding the motion characteristics of the vehicle motion, the dead time, etc. in the driver model is not satisfied for high speed steering wheel steering. Indicating a separated point can therefore be prevented by only presenting the predicted arrival point when the change amount of the steering wheel within the fixed time period is a fixed value corresponding to the vehicle motion and the dead time in the driver model, or less.

Next, explanation follows regarding a predicted arrival point presentation device according to a fifth exemplary embodiment. Note that that same reference numerals are allocated to parts of configuration similar to in the first exemplary embodiment.

The fifth exemplary embodiment mainly differs from the first exemplary embodiment in that the steering gear ratio g_{sw} is fixed.

Configuration of a Predicted Arrival Point Presentation Device According to a Fifth Exemplary Embodiment of the Present Invention

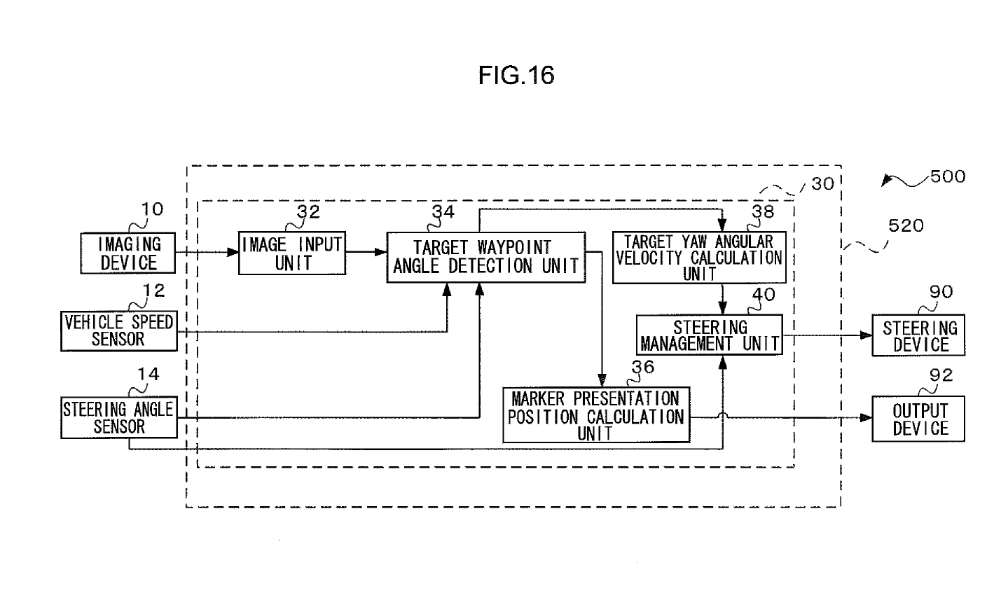

Next, explanation follows regarding configuration of a predicted arrival point presentation device 500 according to a fifth exemplary embodiment of the present invention. As illustrated in FIG. 16, the predicted arrival point presentation device 500 according to the fifth exemplary embodiment of the present invention can be configured by a computer including a CPU, RAM, and ROM stored with programs and various data for executing a gear ratio control processing routine and a marker presentation processing routine described later. The predicted arrival point presentation device 500 includes an imaging device 10, a vehicle speed sensor 12, a steering angle sensor 14, an operation unit 520, a steering device 90, and an output device 92 as functionally illustrated in FIG. 16.

The operation unit 520 includes a marker presentation unit 30. The operation unit 520 does not control the steering gear ratio changing unit.

As explained above, the predicted arrival point presentation device according to the fifth exemplary embodiment of the present invention, when the vehicle is travelling along the route under driving assistance, the location at which the vehicle will arrive after the driver's forward gaze time is predicted based on the steering wheel angle and the vehicle speed. The predicted arrival point can thereby be presented to the driver with high precision by presenting a marker indicating the predicted location of arrival at a position on the windshield of the vehicle.

Next, explanation follows regarding a predicted arrival point presentation device according to a sixth exemplary embodiment. Note that that same reference numerals are allocated to parts of configuration similar to in the first exemplary embodiment.

The sixth exemplary embodiment mainly differs from the first exemplary embodiment in that the target waypoint is determined using GPS data.

Configuration of a Predicted Arrival Point Presentation Device According to a Sixth Exemplary Embodiment of the Present Invention

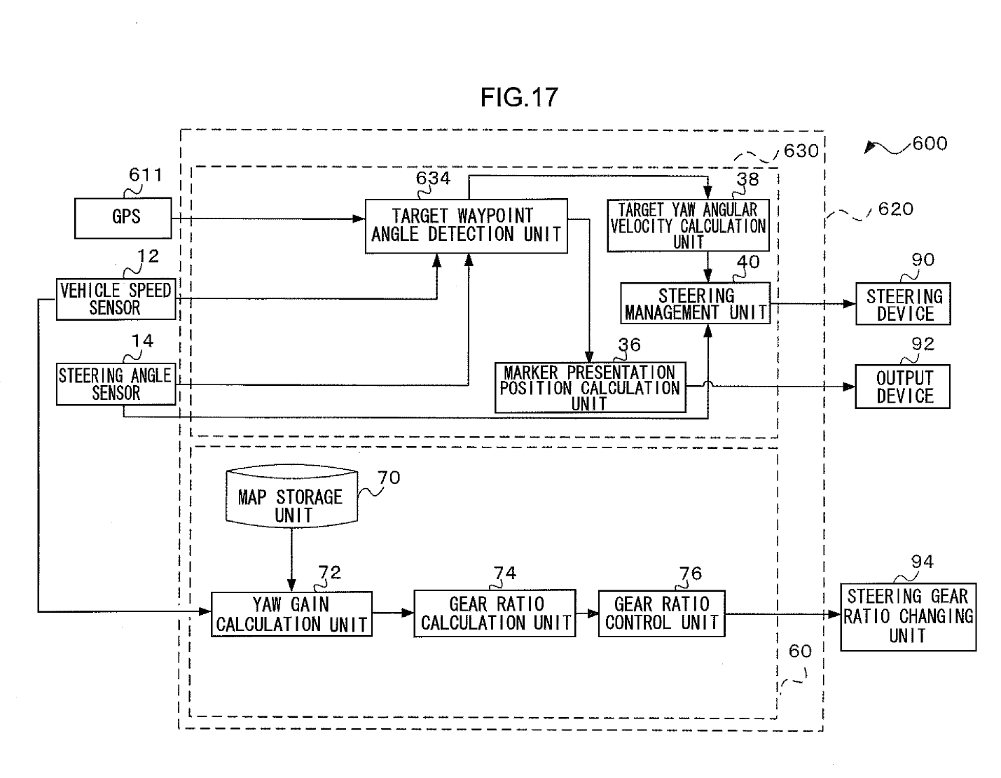

Next, explanation follows regarding configuration of a predicted arrival point presentation device 600 according to a sixth exemplary embodiment of the present invention. As illustrated in FIG. 17, the predicted arrival point presentation device 600 according to the sixth exemplary embodiment of the present invention can be configured by a computer including a CPU, RAM, and ROM stored with programs and various data for executing a gear ratio control processing routine and a marker presentation processing routine described later. The predicted arrival point presentation device 600 includes a GPS 611, a vehicle speed sensor 12, a steering angle sensor 14, an operation unit 620, a steering device 90, an output device 92, and a steering gear ratio changing unit 94 as functionally illustrated in FIG. 17.

The GPS 611 detects positional data of the vehicle.

The operation unit 620 includes a marker presentation unit 630, and a gear ratio adjusting unit 60.

The marker presentation unit 630 superimposes on the windshield of the vehicle a marker indicating the target waypoint after the forward gaze time, based on the positional data of the vehicle input from the GPS 611, the vehicle speed v of the vehicle input from the vehicle speed sensor 12, and the front wheels actual steering angle δ_{f} of the vehicle input from the steering angle sensor 14. The marker presentation unit 630 also controls the vehicle so as to move to the target waypoint. The marker presentation unit 630 includes a target waypoint angle detection unit 634, a marker presentation position calculation unit 36, a target yaw angular velocity calculation unit 38, and a steering management unit 40.

The target waypoint angle detection unit 634 detects the angle θ_{gaze} formed between the travelling direction of the vehicle and the direction of the target waypoint after the forward gaze time based on the positional data of the vehicle detected by the GPS 611, the vehicle speed v of the vehicle detected by the vehicle speed sensor 12, and the front wheel actual steering angle δ_{f} detected by the steering angle sensor 14. Specifically, the target waypoint angle detection unit 634 first calculates the vehicle body slip angle β, according to Equation (21), based on the vehicle speed v detected by the vehicle speed sensor 12, and the front wheel actual steering angle δ_{f} detected by the steering angle sensor 14. Next, the target waypoint angle detection unit 634 calculates the yaw angular velocity r, according to Equation (22), based on the vehicle speed v of the vehicle detected by the vehicle speed sensor 12 and the front wheel actual steering angle δ_{f} detected by the steering angle sensor 14. Next, based on the vehicle speed v of the vehicle detected by the vehicle speed sensor 12 and the calculated yaw angular velocity r, the target waypoint angle detection unit 634 predicts the position of the vehicle after the forward gaze time using the current position of the vehicle as a reference, according to Equation (33) to Equation (35). The target waypoint angle detection unit 634 then finds the angle θ_{gaze} with respect to the direction of the target waypoint after the forward gaze time, based on the predicted position of the vehicle after the forward gaze time.

X(t)=v∫₀^{T}^{_{gaze}} cos(β+θ)dt (33)

Y(t)=v∫₀^{T}^{_{gaze}} sin(β+θ)dt (34)

θ(t)=v∫₀^{T}^{_{gaze}} rdt (35)

Herein, X(t) and Y(t) are a front-rear position and a lateral position at time t, and θ(t) is a yaw angle at time t.

Operation of Marker Presentation Processing of Predicted Arrival Point Presentation Device According to the Sixth Exemplary Embodiment of the Present Invention

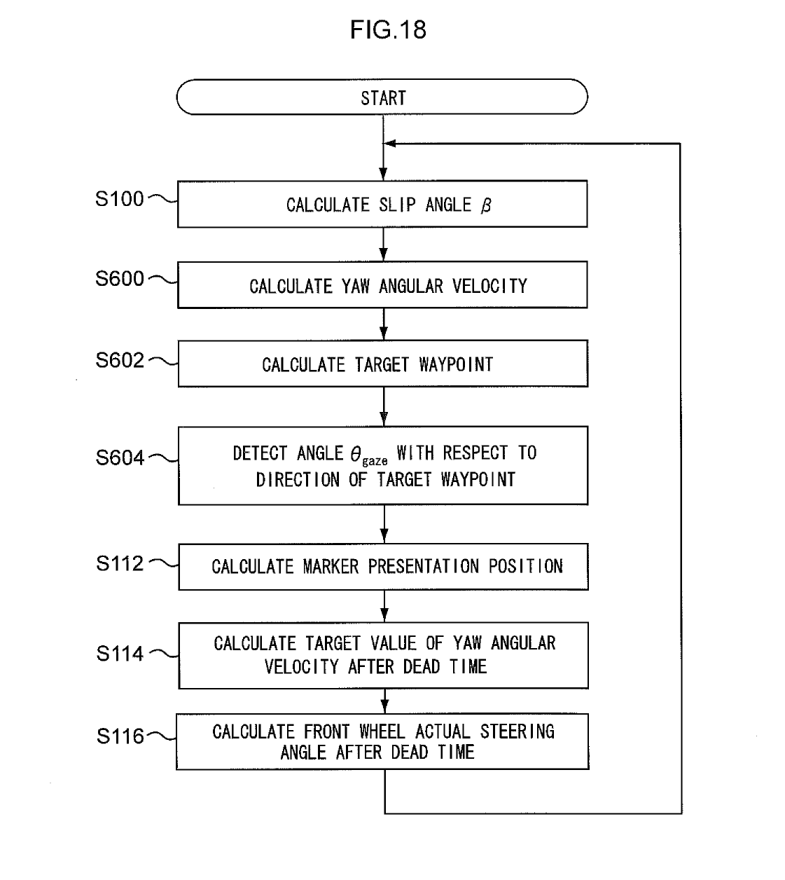

Next, explanation follows regarding operation of marker presentation processing of the predicted arrival point presentation device 600 according to the sixth exemplary embodiment of the present invention. First, when the positional data of the vehicle, the vehicle speed v of the vehicle, and the front wheel actual steering angle δ_{f} of the vehicle have been received from the GPS 611, the vehicle speed sensor 12, and the steering angle sensor 14 while the vehicle installed with the predicted arrival point presentation device 600 is travelling, the marker presentation processing routine illustrated in FIG. 18 is executed by the predicted arrival point presentation device 600.

At step S600, the target waypoint angle detection unit 634 calculates the yaw angular velocity r according to Equation (22), based on the received vehicle speed v and the front wheel actual steering angle δ_{f}.

At step S602, the target waypoint angle detection unit 634 detects the target waypoint based on the received positional data of the vehicle and the yaw angular velocity r acquired at step S600, according to Equation (33) to Equation (35).

At step S604, the target waypoint angle detection unit 634 detects the angle θ_{gaze} with respect to the direction of the target waypoint, based on the position of the target waypoint acquired at step S602.

At step S116, steering management unit 40 calculates the front wheel actual steering angle δ_{f} to achieve the target value of the yaw angular velocity r after the dead time τ acquired at step S114 according to Equation (27). Moreover, the steering management unit 40 sets a timing after the dead time as a specified timing, and stores the calculated front wheel actual steering angle δ_{f} in the memory. The predicted arrival point presentation device 600 then receives the new positional data of the vehicle, the vehicle speed v of the vehicle, and the front wheel actual steering angle δ_{f} of the vehicle from the GPS 611, the vehicle speed sensor 12, and the steering angle sensor 14, and the marker presentation processing routine transitions to step S100.

As explained above, in the predicted arrival point presentation device according to the sixth exemplary embodiment of the present invention, when the vehicle is travelling along the route under driving assistance, the location at which the vehicle will arrive after the driver's forward gaze time is predicted based on the steering wheel angle and the vehicle speed. The predicted arrival point can thereby be presented to the driver with high precision by presenting a marker indicating the predicted location of arrival at a position on the windshield of the vehicle.

Note that the present invention is not limited to the above embodiments. Various modifications and applications are possible within a range not exceeding the spirit of the present invention.

Although the present specification has explained exemplary embodiments in which programs are preinstalled, these programs may be provided stored on a computer readable recording medium, or may be provided over a network.

In the predicted arrival point presentation device of the first aspect, the presentation unit may present the marker only in a case in which a change in a steering wheel angle within a fixed time period, corresponding to dynamic characteristics from the steering wheel angle to the yaw angular velocity, is a reference value or less

In the predicted arrival point presentation device of the first aspect, the presentation unit may present the marker at a position on the windshield while the vehicle under driving assistance achieves a relationship between a steering wheel angle and a yaw angular velocity generated in the vehicle, so as to align a direction of the target location where the vehicle will arrive after the driver's forward gaze time, as viewed from the driver's viewpoint, with a direction of a reference position of the steering wheel, as viewed from the driver's viewpoint

The predicted arrival point presentation device of the first aspect may further include a control unit that achieves a relationship between the steering wheel angle and the yaw angular velocity generated in the vehicle so as to align the direction of the target location where the vehicle will arrive after the driver's forward gaze time, as viewed from the driver's viewpoint, with the direction of a reference position of the steering wheel, as viewed from the driver's viewpoint.

In the predicted arrival point presentation device of the first aspect, the control unit may achieve a relationship between the steering wheel angle and the yaw angular velocity using a steering gear ratio of the vehicle.

In the predicted arrival point presentation device of the first aspect, the control unit may control a steering gear ratio of the vehicle so as to achieve a relationship between the steering wheel angle and the yaw angular velocity generated in the vehicle, the relationship being calculated based on the direction of the target location where the vehicle will arrive after the driver's forward gaze time and the direction of the reference position of the steering wheel.

The predicted arrival point presentation device of the first aspect may further include a vehicle speed detection unit that detects a vehicle speed of the vehicle, and a yaw angular velocity gain calculation unit that calculates a yaw angular velocity gain based on a relationship between the vehicle speed and the yaw angular velocity gain, the relationship being predetermined so as to achieve a relationship between the vehicle speed that is detected by the vehicle speed detection unit and the steering wheel angle, and the yaw angular velocity. Moreover, the control unit may control a steering gear ratio so as to achieve the yaw angular velocity gain that is calculated by the yaw angular velocity gain calculation unit.

The predicted arrival point presentation device of the first aspect may further include a vehicle speed detection unit that detects a vehicle speed of the vehicle, a steering angle detection unit that detects the steering wheel angle, and a yaw angular velocity calculation unit that calculates a target yaw angular velocity based on the vehicle speed that is detected by the vehicle speed detection unit, the steering wheel angle that is detected by the steering angle detection unit, and a relationship between the steering wheel angle and the yaw angular velocity. Moreover, the control unit may control a steering gear ratio so as to achieve the target yaw angular velocity that is calculated by the yaw angular velocity calculation unit.

In the predicted arrival point presentation device of the first aspect, the presentation unit may include a marker presentation position calculation unit that calculates a position on the windshield of the vehicle at which to present a marker indicating a target location of arrival, based on the target location of arrival that is predicted by the arrival location prediction unit, and the marker indicating the target location of arrival may be presented at the position calculated by the marker presentation position calculation unit.

In the predicted arrival point presentation device of the first aspect, the forward gaze time may be from 2.5 seconds to 3.5 seconds.

What is claimed is:

1. A predicted arrival point presentation device, comprising:
an arrival location prediction unit that predicts, based on a target course, a target location of arrival of a vehicle after a forward gaze time of a driver while the vehicle is travelling along a route under driving assistance; and
a presentation unit that presents, at a position on a windshield of the vehicle, a marker indicating the target location of arrival that is predicted by the arrival location prediction unit.

2. The predicted arrival point presentation device of claim 1, wherein the presentation unit presents the marker only in a case in which a change in a steering wheel angle within a fixed time period, corresponding to motion characteristics that achieve a yaw angular velocity from the steering wheel angle, is a reference value or less.

3. The predicted arrival point presentation device of claim 1, wherein the presentation unit presents the marker at a position on the windshield while the vehicle under driving assistance achieves a relationship between a steering wheel angle and a yaw angular velocity that is generated in the vehicle so as to align a direction of the target location of arrival of the vehicle after the driver's forward gaze time, as viewed from the driver's viewpoint, with a direction of a reference position of the steering wheel, as viewed from the driver's viewpoint.

4. The predicted arrival point presentation device of claim 1, further comprising a control unit that achieves a relationship between a steering wheel angle and a yaw angular velocity that is generated in the vehicle so as to align a direction of the target location where the vehicle will arrive after the driver's forward gaze time, as viewed from the driver's viewpoint, with a direction of a reference position of the steering wheel, as viewed from the driver's viewpoint.

5. The predicted arrival point presentation device of claim 4, wherein the control unit achieves a relationship between the steering wheel angle and the yaw angular velocity using a steering gear ratio of the vehicle.

6. The predicted arrival point presentation device of claim 4, wherein the control unit controls a steering gear ratio of the vehicle so as to achieve a relationship between the steering wheel angle and the yaw angular velocity that is generated in the vehicle, calculated based on the direction of the target location where the vehicle will arrive after the driver's forward gaze time and the direction of the reference position of the steering wheel.

7. The predicted arrival point presentation device of claim 4, further comprising:
a vehicle speed detection unit that detects a vehicle speed of the vehicle; and
a yaw angular velocity gain calculation unit that calculates a yaw angular velocity gain based on a relationship between the vehicle speed and the yaw angular velocity gain, which is predetermined so as to achieve the vehicle speed that is detected by the vehicle speed detection unit and a relationship between the steering wheel angle and the yaw angular velocity, wherein
the control unit controls a steering gear ratio so as to achieve the yaw angular velocity gain that is calculated by the yaw angular velocity gain calculation unit.

8. The predicted arrival point presentation device of claim 4, further comprising:
a vehicle speed detection unit that detects a vehicle speed of the vehicle;
a steering angle detection unit that detects the steering wheel angle; and
a yaw angular velocity calculation unit that calculates a target yaw angular velocity based on the vehicle speed that is detected by the vehicle speed detection unit, the steering wheel angle that is detected by the steering angle detection unit, and a relationship between the steering wheel angle and the yaw angular velocity,
wherein the control unit controls a steering gear ratio so as to achieve the target yaw angular velocity that is calculated by the yaw angular velocity calculation unit.

9. The predicted arrival point presentation device of claim 1, wherein:
the presentation unit includes a marker presentation position calculation unit that calculates a position on the windshield of the vehicle to present a marker indicating a target location of arrival, based on the target location of arrival that is predicted by the arrival location prediction unit; and
the marker indicating the target location of arrival is presented at the position calculated by the marker presentation position calculation unit.

10. The predicted arrival point presentation device of claim 1, wherein the forward gaze time is from 2.5 seconds to 3.5 seconds.

11. A computer readable medium storing a program causing a computer to execute a process for marker presentation, the process comprising:
predicting, based on a target course, a target location of arrival of a vehicle after a forward gaze time of a driver while the vehicle is travelling along a route under driving assistance; and
presenting, at a position on a windshield of the vehicle, a marker indicating the target location of arrival that has been predicted.
